(19) United States
(12) Patent Application Publication
(10) Pub. No.: US 2024/0220737 A1
(43) Pub. Date: Jul. 4, 2024

(54) PROBABILISTIC MULTI-PARTY AUDIO TRANSLATION

(71) Applicant: Mass Luminosity, Inc., Lake Dallas, TX (US)

(72) Inventors: Angel MUNOZ, Dallas, TX (US); Teodor ATROSHENKO, Valencia (ES)

(73) Assignee: Mass Luminosity, Inc., Lake Dallas, TX (US)

(21) Appl. No.: 18/492,635

(22) Filed: Oct. 23, 2023

Related U.S. Application Data
(60) Provisional application No. 63/435,701, filed on Dec. 28, 2022.

(51) Int. Cl. G06F 40/47

(52) U.S. Cl. CPC G06F 40/47

(57) ABSTRACT

A method implements probabilistic multi-party audio translation. The method includes receiving input text of a communication session. The method further includes processing the input text with a prediction model and a translation model to generate translation data. The method further includes processing the translation data and enunciation data with a sentence similarity model to generate a similarity score. The method further includes presenting the enunciation data based on the similarity score.

### CROSS REFERENCE TO RELATED APPLICATIONS

This application claims the benefit of US Provisional Application No. 63/435,701, filed Dec. 28, 2022, which is incorporated by reference herein.

### BACKGROUND

Existing live translation (interpreting) technology involves having to wait for the speaker to finish speaking an utterance before the translator may begin enunciating possible translation. In case mistaken translation was enunciated (e.g., omission, addition, misinformation, misorder, or blends), the translator may re-enunciate an updated translation from the start. In other implementations, a translator may wait for the speaker to finish speaking a sentence before beginning to enunciate the final translation, in order to avoid corrections (and by extension re-enunciations), thus causing large delays between the speaker finishing their speech and the listener hearing its translation in its entirety.

Conference calls are used for real time communication between different people using different devices. A conference call may include multiple media streams to communicate audio, video, and text between multiple participants. Participants to a conference call may communicate by speaking and sending text messages with different languages. The different languages may be translated for the different participants. Challenges include performing translations in real time during a conference call and handling inaccurate translations and corrections.

### SUMMARY

In general, in one or more aspects, the disclosure relates to a method implementing probabilistic multi-party audio translation. The method includes receiving input text of a communication session. The method further includes processing the input text with a prediction model and a translation model to generate translation data. The method further includes processing the translation data and enunciation data with a sentence similarity model to generate a similarity score. The method further includes presenting the enunciation data based on the similarity score.

In general, in one or more aspects, the disclosure relates to a system implementing probabilistic multi-party audio translation. The system includes at least one processor and an application executing the at least one processor. The application configured to perform receiving input text of a communication session. The application further configured to perform processing the input text with a prediction model and a translation model to generate translation data. The application further configured to perform processing the translation data and enunciation data with a sentence similarity model to generate a similarity score. The application further configured to perform presenting the enunciation data based on the similarity score.

In general, in one or more aspects, the disclosure relates to a method implementing probabilistic multi-party audio translation. The method includes receiving input text of a communication session. The method further includes processing the input text with a prediction model and a translation model to generate translation data. The method further includes processing the translation data and enunciation data with a sentence similarity model to generate a similarity score. The method further includes presenting the enunciation data based on the similarity score as synthesized audio in an audio stream of a live media stream of the communication session.

Other aspects of the invention will be apparent from the following description and the appended claims.

### BRIEF DESCRIPTION OF DRAWINGS

FIG. 1 shows a diagram of systems in accordance with disclosed embodiments.

FIG. 2 shows a flowchart in accordance with disclosed embodiments.

FIG. 3A, FIG. 3B, FIG. 3C, FIG. 3D, FIG. 3E, FIG. 3F, FIG. 3G, FIG. 3H, FIG. 3I, FIG. 3J, FIG. 3K, FIG. 3L, FIG. 3M, FIG. 4, FIG. 5, FIG. 6, FIG. 7, FIG. 8A, FIG. 8B, FIG. 8C, FIG. 8D, FIG. 9, FIG. 10, FIG. 11A, FIG. 11B, FIG. 11C, FIG. 11D, and FIG. 12 show examples in accordance with disclosed embodiments.

FIG. 13A and FIG. 13B show computing systems in accordance with disclosed embodiments.

### DETAILED DESCRIPTION

Embodiments according to the disclosure permit near-instant (e.g., with best-effort predetermined maximum delay) translation that may finish enunciation (of the translation) at or nearly at the same time as the speaker. Embodiments according to the disclosure may use a variety of approaches to reduce the number of mistakes, reduce the number of re-enunciations (or corrections) that are to be made, reduce the time of enunciation preparation (e.g., speech synthesis), and provide near-instant enunciation with little to no interruptions in the flow of translated speech.

In general, embodiments performing translations in real time during a conference call and handling inaccurate translations and corrections to perform probabilistic multi-party audio translation. A user of the system connects to a conference call with a user device (a mobile phone, computer, etc.). When a language is identified in a call that is not the preferred language of a user, the language is translated to the preferred language of the user in real time during the call.

For example, members of a team based in America, may be having a conference call with members of a team based in Europe who speak and text using several different languages. For each user on the call, the system may translate to a preferred language of the user and play translated audio and display translated text.

A prediction model is used in conjunction with a translation model to predict text or speech and prefill a cache with expected phrases so that translated audio may be continuously played. The system monitors a time threshold, e.g., 5 seconds, and may adjust a playback rate of translated audio in order to present the translated audio within the time identified by the time threshold for real time communication between the users of the system.

Embodiments in accordance with the disclosure provide (near) real-time voice-to-voice translation in multi-language environment, e.g., voice and video conference calls. Time-guarantees for translation may be provided, e.g., a translation will be provided within “two seconds”, of a speaker finishing his or her speech. Optional dynamic read-back speed may have the translation speed accelerated to match the speaker speed. Predictive and probabilistic translation may be utilized, e.g., the translation may be inaccurate or incomplete when “spoken” to the recipient and different versions of translation may be synthesized “on-the-fly” and played back when higher confidence is achieved, or a time limit is approaching. The system allows for inaccuracies in translation to happen but mitigates the impact to understanding the meaning of the input.

The following terms may be used in describing aspects of the disclosure.

Enunciation—audio or visual display of translated transcript/phrase/utterance, which may include closed captions displayed on the screen.

Enunciation queue or queued enunciations—the audio that was synthesized or which is pending to be synthesized before playing out to the user. The user has not yet heard this audio. Queued enunciations may be de-queued and replaced.

Correction—when applied to audio, a correction may include an audible “err” or “correction” followed by the corrected words, or implicit backtracking to the place where the mistake was made followed by the corrected words. For example, “The sky is green, err, blue”, where just one word is to be ‘fixed’. In another example, “We disregarded the following conclusions [short pause] We've come to the following conclusions”, where more than one word or a word earlier in the enunciated phrase is to be ‘fixed’. When applied to captions, a correction may replace the displayed incorrect words with the updated words.

Similarity model—determines if two phrases are similar. For example, “I like cats” and “I like kittens” are very similar (e.g., 0.99 similarity score), while “I like cats” and “I like dogs” are very distinct and one phrase cannot replace the other without distorting the meaning of the phrase (e.g., 0.15 similarity score).

Most suitable translated transcript—the transcript selected for enunciation in the last stage of the pipeline, save for corrections. If no corrections are to be issued, then the most suitable translated transcript (or a part thereof) is appended to the current enunciation data.

Interim results—the transcription (speech-to-text) results that are returned before a speaker is done speaking. The results may be returned with about one second delay. For example, a person says “apple”, one second later the recognition service returns interim results containing “apple”, then another second later, if no further voice activity had been detected, the final result containing “apple” is provided.

Combined enunciation or final enunciation—the combination of each of the enunciations that were ever produced in its most canonical form. In case of audio enunciations, this would represent the entire phrase that was spoken to the user with each of the explicit corrections. In case of visual enunciations, this would represent the entire phrase with no visible corrections—this phrase already has each of the corrections applied and conceptually represents what would be shown on the screen, should the user rewind to the previous portion of the stream/call recording.

The figures of the disclosure show diagrams of embodiments that are in accordance with the disclosure. The embodiments of the figures may be combined and may include or be included within the features and embodiments described in the other figures of the application. The features and elements of the figures are, individually and as a combination, improvements to the technology of computer implemented translation. The various elements, systems, components, and steps shown in the figures may be omitted, repeated, combined, and/or altered as shown from the figures. Accordingly, the scope of the present disclosure should not be considered limited to the specific arrangements shown in the figures.

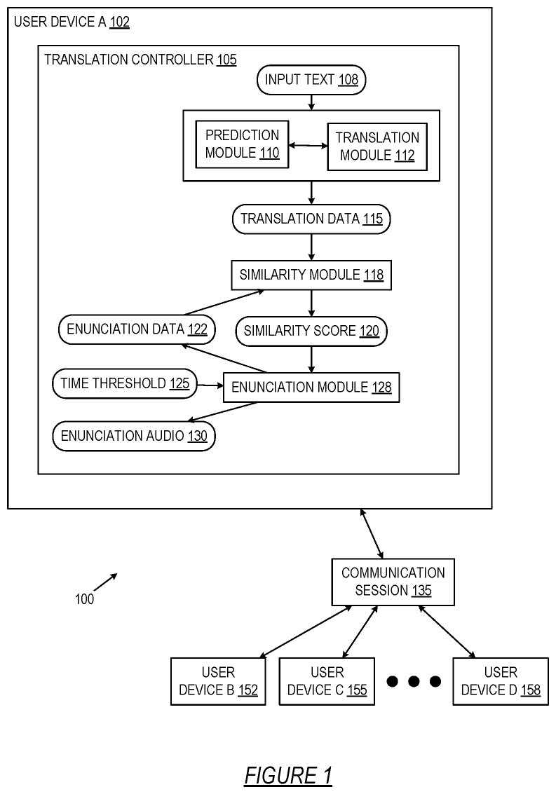

Turning to FIG. 1, the system (100) includes the user devices A (102) and B (152) through D (158). The user devices A (102) and B (152) through D (158) are participating in the communication session (135). The user device A (102) includes the translation controller (105).

The translation controller (105) is a collection of hardware and software components that include programs with instructions that may operate on the user device A (102). The translation controller (105) translates the input text (108) between different languages using the prediction module (110) and the translation module (112). The translation controller (105) may also present translated text as the enunciation audio (130) using the similarity module (118) and the enunciation module (128).

The input text (108) is text that is to be translated by the system (100). The input text (108) may include text messages of a user of the user device A (102), which may be entered with a keyboard. The input text (108) may include transcribed audio text. The transcribed audio text may be generated by the user device A (102) by capturing audio with the user device A (102) and converting speech from the captured audio to text. The input text (108) forms an input to the prediction module (110) and the translation module (112).

The prediction module (110) is a collection of hardware and software components that include programs with instructions that may operate on the user device A (102). The prediction module (110) may be applied to the input text (108), to translated from the translation module (112), combinations thereof, etc. The prediction module (110) predicts a word or sequence of words from an input sequence. For example, the prediction module (110) may predict the next word that is expected after the most recent word from the input text (108). In one embodiment, the prediction module (110) uses a machine learning model (e.g., a large language model (LLM)) to generate prediction text. The prediction module (110) may use machine learning models, which may include artificial neural networks, which may include attention layers, recurrent layers, fully connected layers, etc. The prediction module (110) may take text as input, word vectors as input, tokens, etc. The prediction module (110) may output text, word vectors, tokens, etc.

In one embodiment, text is a string of characters. In one embodiment, text may be split into an array of word strings with an element of the array comprising a string for a word or phrase from the original text.

In one embodiment, a word vector is collection of values that identifies a location of a word in a vector space that corresponds to a meaning in a semantic space. Words with similar meanings in the semantic space have similar locations in the vector space.

In one embodiment, a token is a value that represents a word or group of words. The group of words may be a commonly used phrase or collection of words and may be a collection of different forms of a word.

In one embodiment, the prediction module (110) may include multiple models. Each of the models may correspond to different languages. In one embodiment, the prediction module (110) may identify a language from the input to the prediction module (110) and select a model trained for the corresponding language.

In one embodiment, a threshold may be used to identify the number of words the prediction module (110) will predict. For example, the input text (108) may include ten words and the prediction module (110) may have a prediction threshold of two words to form an output corresponding to twelve words. In one embodiment, the prediction module (110) may predict words until a stop token (e.g., a period (“.”)) is predicted.

The translation module (112) is a collection of hardware and software components that include programs with instructions that may operate on the user device A (102). The translation module (112) may be applied to the input text (108), to predicted text from the prediction module (110), combinations thereof, etc. In one embodiment, the translation module (112) uses a machine learning model (e.g., a large language model (LLM)) to generate translation text. The translation module (112) translates word or sequences of words from an input language to an output language. The input language may be detected by the translation module (112) and the output language may be identified from a user profile. The translation module (112) may use machine learning models, which may include artificial neural networks, which may include attention layers, recurrent layers, fully connected layers, etc. The translation module (112) may take text as input, word vectors as input, tokens, etc. The translation module (112) may output text, word vectors, tokens, etc.

In one embodiment, the translation module (112) may include multiple models. Each of the models may correspond to different languages or pairs of languages. In one embodiment, the translation module (112) may identify a language from the input to the translation module (112), identify an output language from a user, and select a model trained for the corresponding languages. The output language may be identified from a profile created by the user, text messages sent by the user, transcription audio from the user, transcription text from the transcription audio, etc.

The translation data (115) is the output from the prediction module (110) and the translation module (112). The translation data (115) may include predictions from the prediction module (110) and translations from the translation module (112). The translation data (115) may be a text string of words, a sequence of word strings, a sequence of word vectors, a sequence of tokens, etc., that corresponded and are updated with changes to the input text (108). In one embodiment, the translation data (115) may include multiple words that are a potential translation for a word from the input text (108). When multiple words are provided in the translation data (115) for a corresponding word from the input text (108), a confidence score may also be provided for each word of the translation data (115) that identifies a likelihood that the word in the translation data (115) is a correct translation of the corresponding word from the input text (108).

The similarity module (118) is a collection of hardware and software components that include programs with instructions that may operate on the user device A (102). The similarity module (118) compares the translation data (115) to the enunciation data (122) to generate the similarity score (120) for the input text (108). In one embodiment, the similarity module (118) may use a cosine similarity between the translation data (115) and the enunciation data (122) to generate the similarity score (120).

The similarity score (120) identifies the similarity between the translation data (115) and the enunciation data (122). In one embodiment, a similarity score is generated for each word, vector, token, etc., of the translation data (115) and the enunciation data (122). The scores of each of the words, vectors, tokens, etc., may be stored in a sequence of scores to form the similarity score (120).

The enunciation data (122) includes data enunciated by the translation controller (105). In one embodiment, the enunciation data (122) includes previous translation data (stored as a text string of words, sequence of vectors, sequence of tokens, etc.). In one embodiment, the enunciation data (122) may include one or more pointers to identify, e.g., words that have been enunciated, words that are being enunciated, and words that will be enunciated. The enunciation data (122) may also include time codes corresponding to one or more of the words in the enunciation data (122). The time codes may identify when a word was originally spoken by a user, identify when the spoken word was received in a stream by the user device A (102), and identify when a corresponding word of a translation is to be spoken using the time threshold (125).

The time threshold (125) identifies when a word from the enunciation data (122) is to be spoken. For example, when the time threshold (125) is 3 seconds, the words from the enunciation data (122), which correspond to the words of the input text (108), are to be spoken no later than 3 seconds after the words form the input text (108) were received by the user device A (102).

The enunciation module (128) is a collection of hardware and software components that include programs with instructions that may operate on the user device A (102). The enunciation module (128) processes the similarity score (120) to update the enunciation data (122) with the translation data (115). For example, the enunciation module (128) may determine that one or more words in the enunciation data (122) that have already been enunciated are different from words in the translation data (115). To address the difference between the words in the enunciation data (122) and the translation data (115), the enunciation module (128) may update the enunciation data (122) with the translation data (115) and may adjust pointers to the enunciation data (122).

The enunciation audio (130) is audio that is played to a user. For example, the enunciation audio (130) may be a streaming audio file played to the user that is continuously updated with synthesized audio versions of the words from the enunciation data (122) that correspond to the input text (108).

The communication session (135) is a live streaming session between the user devices A (102) and B (152) through D (158). The communication session (135) may be a conference call that includes one or more video, audio, and chat message streams between the participants using the user devices A (102) and B (152) through D (158). The communication session (135) may be a one-to-many or many-to-many stream session between the participants using the user devices A (102) and B (152) to stream and viewers using the user devices C (155) through D (158) to watch the stream.

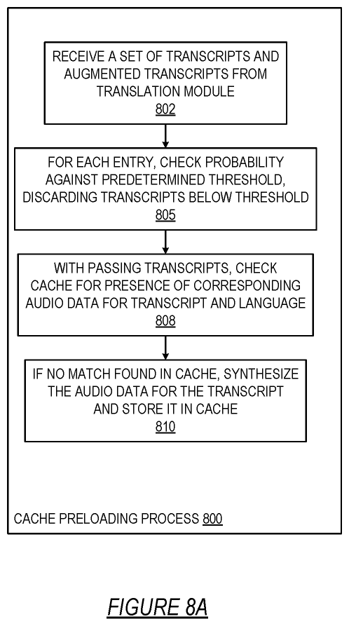

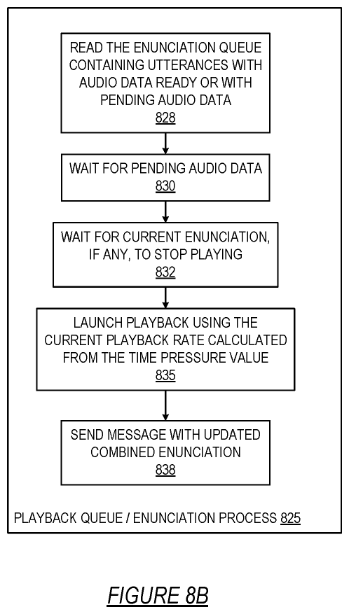

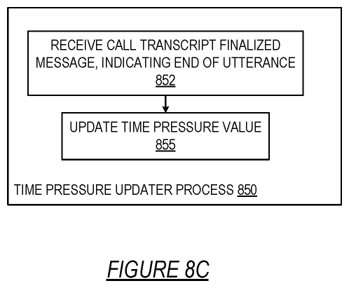

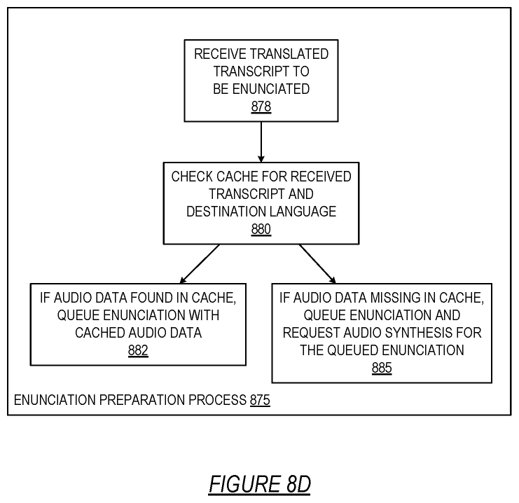

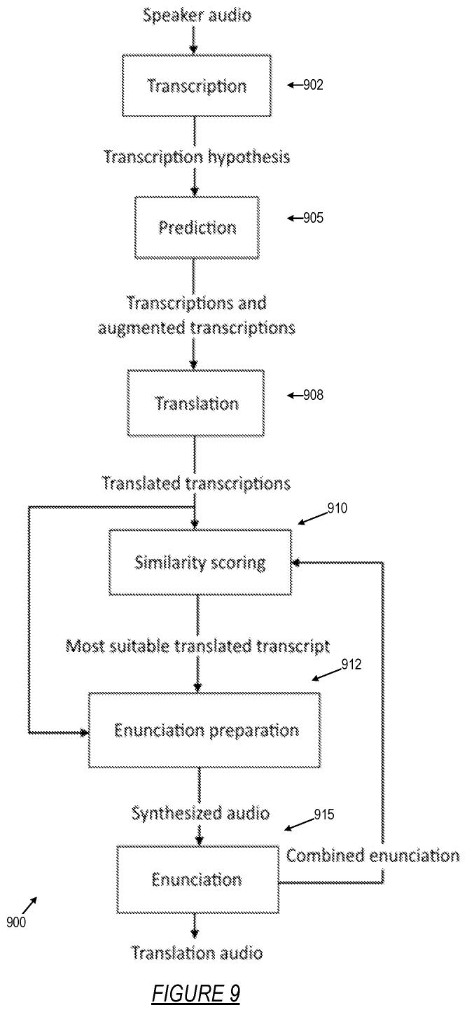

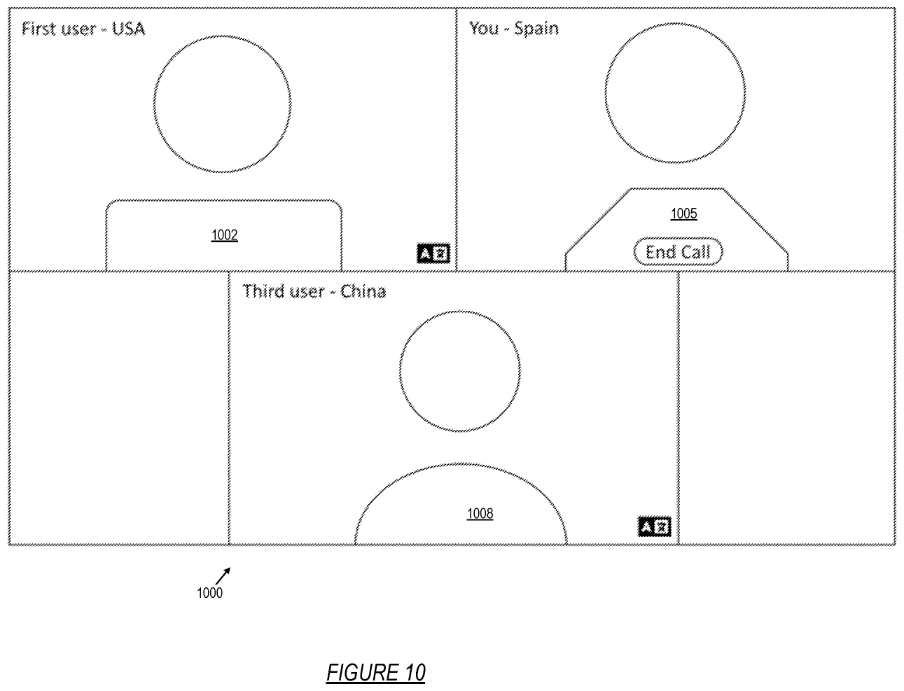

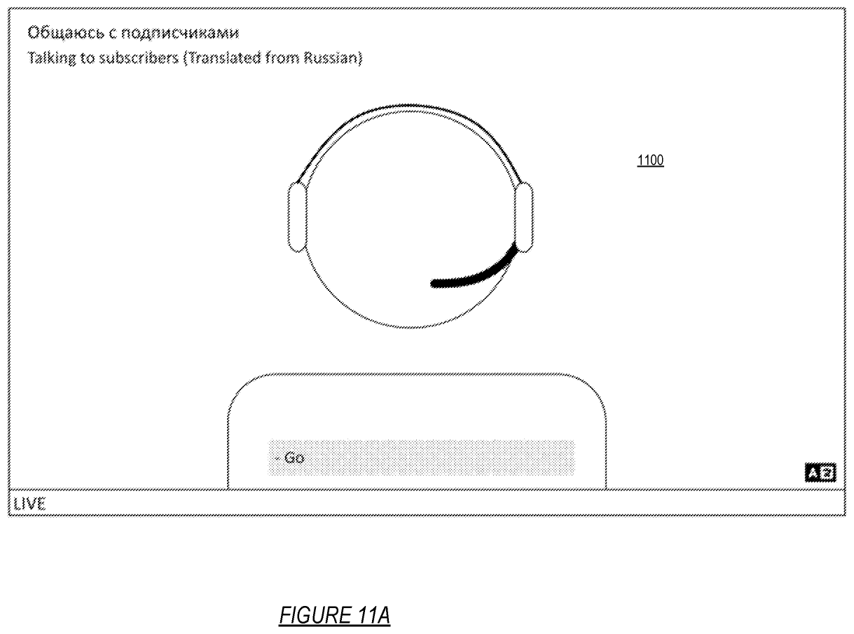

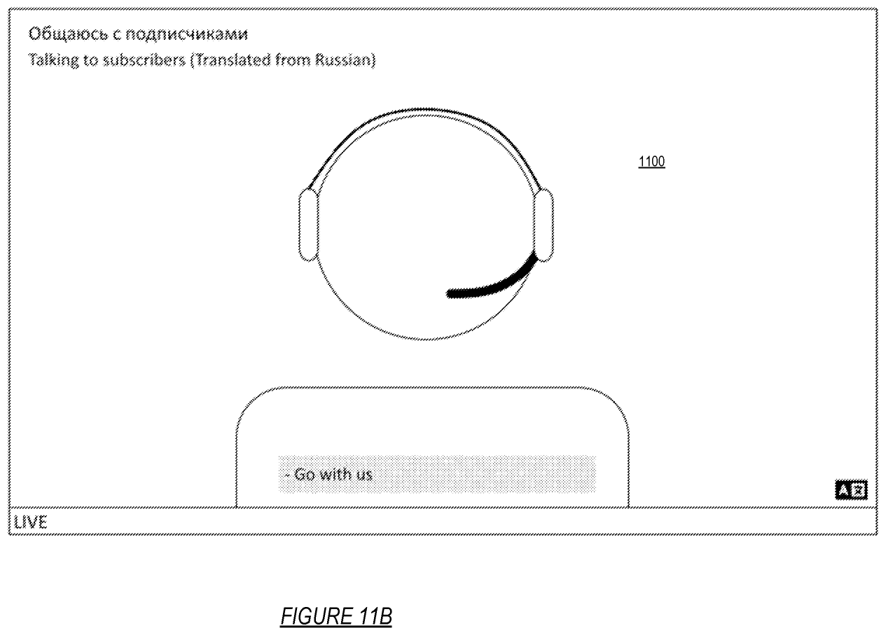

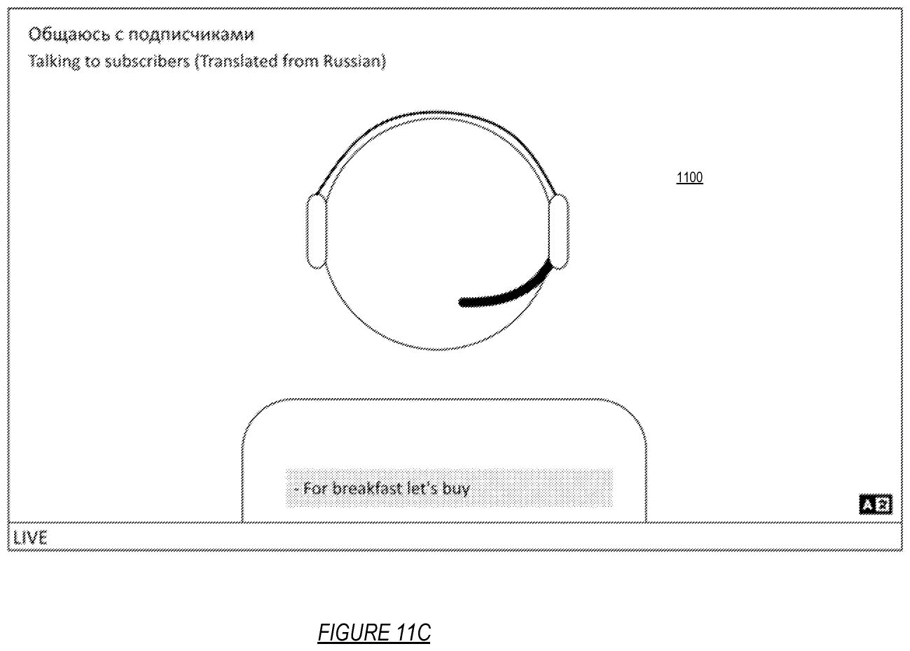

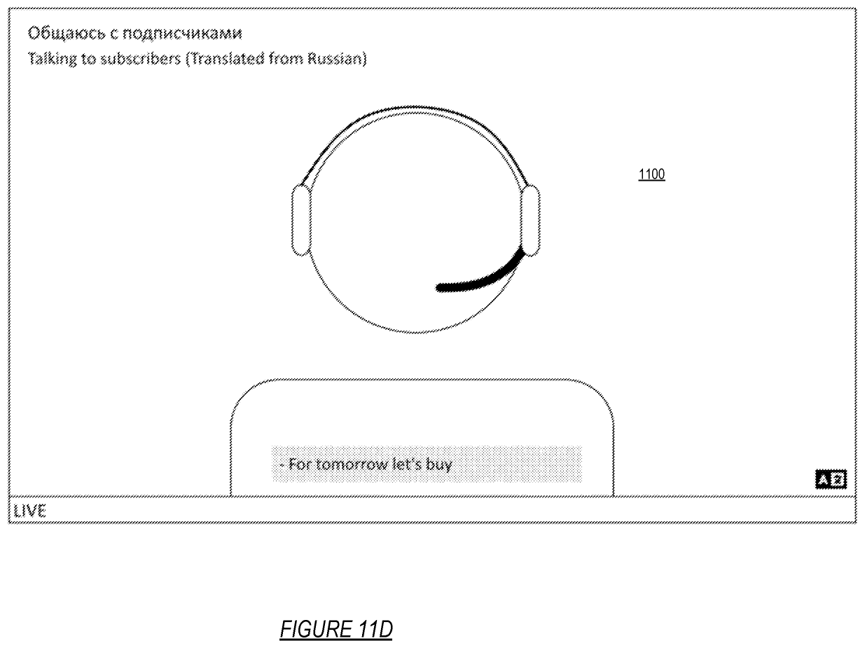

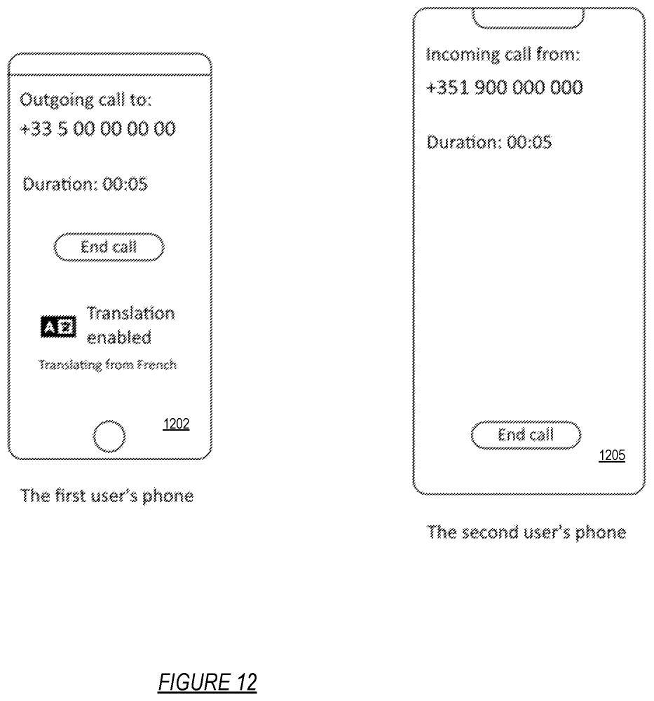

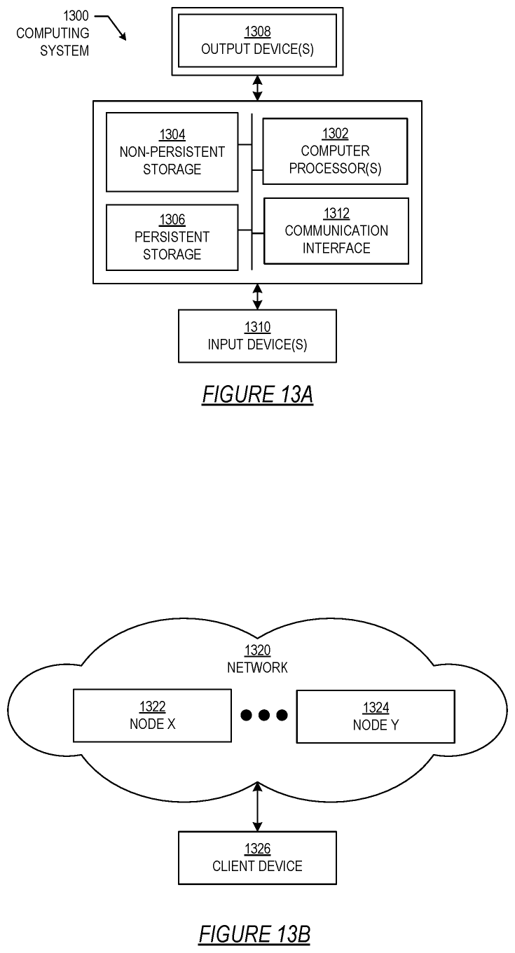

The user devices A (102) and B (152) through D (158) are computing systems (further described in FIG. 13A). For example, the user devices A (102) and B (152) through D (158) may be desktop computers, mobile devices, laptop computers, tablet computers, server computers, etc. The user devices A (102) and B (152) through D (158) include hardware components and software components that operate as part of the system (100). The user devices A (102) and B (152) through D (158) communicate with each other to present multimedia streams for conference calls. The user devices A (102) and B (152) through D (158) may communicate using standard protocols and file types, which may include hypertext transfer protocol (HTTP), HTTP secure (HTTPS), transmission control protocol (TCP), internet protocol (IP), hypertext markup language (HTML), extensible markup language (XML), etc. The user devices A (102) and B (152) through D (158) may each include user applications for users to interact with the system (100) and participate in a conference call.

In one embodiment, each of the user devices A (102) and B (152) through D (158) may individually perform translations for the users of the respective devices. For example, the user device A (102) may receive audio and text streams from each of the user device B (152), the user device C (155), and the user device D (158). The user device B (152) may translate each of the received streams before presenting the translated stream (audio or text) to the user of the user device B (152).

In one embodiment, the user devices A (102) and B (152) through D (158) may receive streams with translated text and translated audio from other ones of the user devices A (102) and B (152) through D (158). In one embodiment, a centralized server may be part of the system (100) (e.g., the user device D (158)), receive streams from the user devices A (102) and B (152) through C (155), and provide translated streams (audio, text, etc.) to the user devices A (102) and B (152) through C (155).

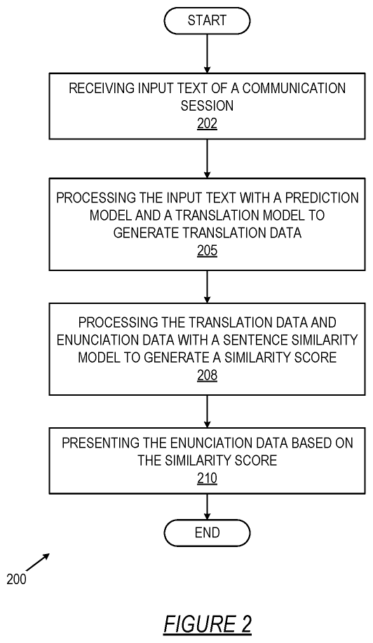

Turning to FIG. 2, the process (200) implements probabilistic multi-party audio translation. The process (200) may be performed by a computing device interacting with one or more additional computing devices. For example, the process (200) may execute on a desktop computer in response to one or more user devices.

At Step 202, input text of a communication session is received. In one embodiment, the communication session includes one or more live media streams from user devices. The media streams may include audio streams and text streams. In one embodiment, an audio stream may be transcribed with a speech-to-text model to generate transcription text that forms the input text. In one embodiment, a text stream includes text messages between the participants of the communication session, which may form the input text.

At Step 205, the input text is processed with a prediction model and a translation model to generate translation data. In one embodiment, the input text is converted to word vectors to which one or more of the prediction and translation models are applied. Prediction may be performed before, after or both before and after the translation.

In one embodiment, processing the input text includes converting words from the input text to word vectors. The conversion may be performed with an embedding layer of a neural network. The embedding layer may be pretrained or trained outside of the prediction model and translation model.

In one embodiment, the input text is processed with the prediction model. After processing with the prediction model, the output from the prediction model is processed with the translation model to generate the translation data.

In one embodiment, the input text is processed with the translation model. After processing with the translation model, the output from the translation model is processed with the prediction model to generate the translation data.

At Step 208, the translation data and enunciation data are processed with a sentence similarity model to generate a similarity score. In one embodiment, the translation data includes predictions and translations from the input text and the enunciation data includes what has been, is being, and will be presented (e.g., through audio playback or subtitles) to a user. The translation data and the enunciation data are input to the sentence similarity model, which outputs a similarity score. The similarity score identifies the similarity between the meaning of the translation data and the enunciation data. In one embodiment, the similarity score includes a value for pairs of corresponding words between the translation data and the enunciation data. The similarity score may be compared to a similarity threshold to adjust the enunciation data.

In one embodiment, the enunciation data is adjusted with the translation data when the similarity score satisfies a similarity threshold. For example, each word in the enunciation data may correspond to a word in the translation data. When the similarity score for corresponding words from the enunciation data and the translation data does not meet the similarity threshold, the system may replace the word from the enunciation data with the word from the translation data. If the word being replaced has already been presented (e.g., by audio playback), then the system may present the replaced word (e.g., again by audio playback) to the user as a correction.

For example, enunciation data predicted and translated from input text includes “he put the keys on the table” and the system plays audio for “he put the keys on the”. During playback, the system receives more input text, and the translation data includes “he placed the keys in the safe”. The value of the similarity score between “put” and “placed” is high enough to meet the similarity threshold but value of the similarity score between “on” and “in” and between “table” and “safe” do not meet the similarity threshold. The system may adjust the enunciation data to be “he put the keys in the safe” and then play audio for “in the safe” as a correction to the audio of “on the”, which has already been played.

At Step 210, the enunciation data is presented based on the similarity score. In one embodiment, portions of the enunciation data may be replaced with corresponding portions from the translation data. For example, when the value of the similarity score for a word from the enunciation data compared to a corresponding word from the translation data does not meet the similarity threshold (e.g., 80%), then a correction may be identified and recorded that replaces the word in the enunciation data with the corresponding word from the translation data.

In one embodiment, the enunciation data is presented using a time threshold identifying when the enunciation data for the input text is to be presented. For example, the time threshold of five seconds may indicate that a word from the input text is to be presented (e.g., enunciated, printed, etc.) within five seconds of being received as part of the communication session. In one embodiment, each word from the input text may be associated with a corresponding time value that identifies when the word from the input text was received. The time threshold may be applied to each time value to identify a time for each word for which the system is to present the translation.

As an example, the system receives the input text “he placed the keys” and the words are respectively associated with time values of “123.0”, “123.2”, “123.5”, “123.6”. The time value of “123.0” indicates that the word “he” was received “123.0” seconds into the communication session. Adding the time threshold to the received time values creates the time limit values of “128.0”, “128.2”, “128.5”, “128.6”. The time limit value of “128.0” indicates that the corresponding word (“he”) is to be presented no later than “128.0” seconds into the communication session.

In one embodiment, a playback rate is determined using a time threshold and a time value of the input text. After determining the playback rate, the enunciation data may be presented using the playback rate.

Continuing the example above for the phrase “he placed the keys”, the system identifies that “keys” was received at “123.6” seconds into the communication session and is to be presented to the user by “128.6” seconds into the communication session. Additionally, the entire phrase is to be presented which will take “1” second to play. However, the current time on the communication session is “128.1” seconds. The system determines that the “1” second of audio is to be played in “0.5” seconds of time for a playback rate of “2.0” times normal speed.

In one embodiment, the enunciation data is presented as synthesized audio in an audio stream of a live media stream of the communication session. For example, the system may use a text to speech model to convert words from the enunciation data to synthesized speech stored in a sound file. The sound file may be sent and played as part of an audio stream of the communication session.

In one embodiment, the enunciation data is presented as subtitle text in a video stream of a live media stream of the communication session. For example, the system may convert groups of words from the enunciation data to entries of a subtitle file (e.g., an “SRT” file) that identifies sequences of words with start times and stop times for when the sequences will appear in video as part of a video stream of the communication session.

In one embodiment, a correction is presented from the enunciation data after adjustment of the enunciation data when the similarity score satisfies a similarity threshold. The correction may be recorded by the system to identify a word in the enunciation data that is replaced by a word in the translation data when the value of the similarity score for the word from the enunciation data and the word from the translation data do not satisfy the similarity threshold.

In one embodiment, a correction from the enunciation data is presented after adjustment of the enunciation data and adjustment of a playback rate. For example, the enunciation data may be adjusted from “he placed the keys on the table” to “he placed the keys in the safe” and the system may identify a playback speed of “1.5” times normal speed to meet the time threshold.

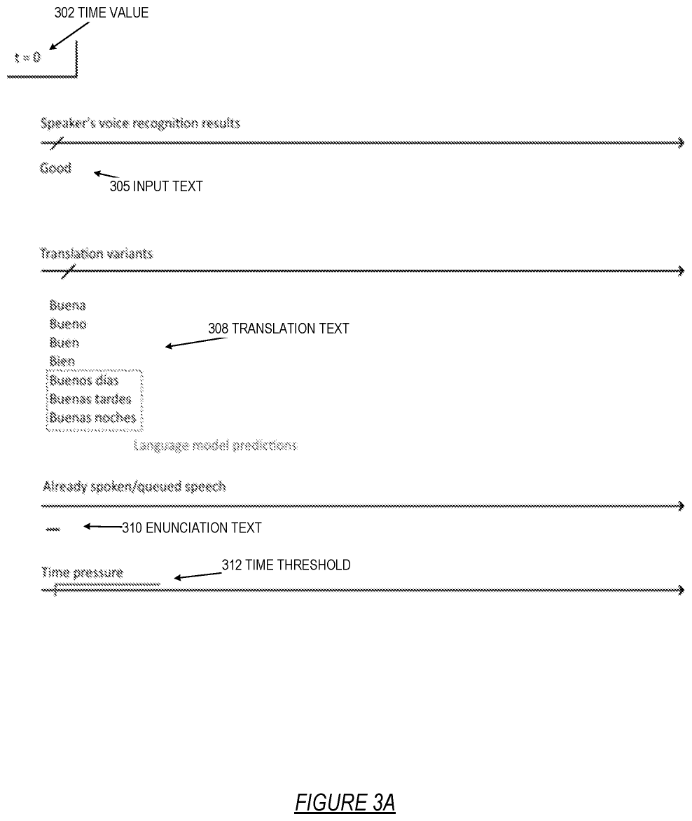

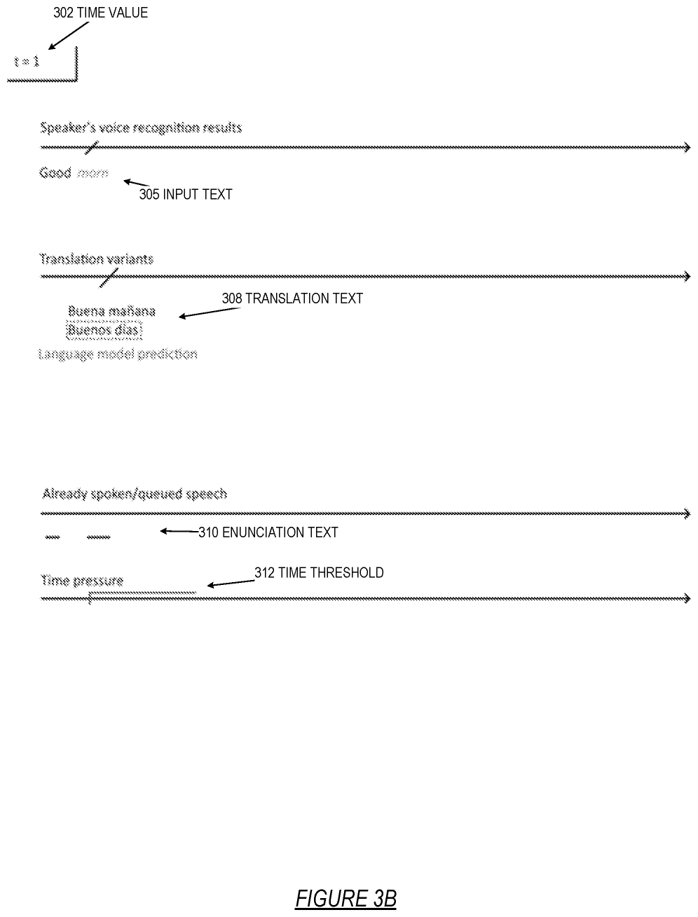

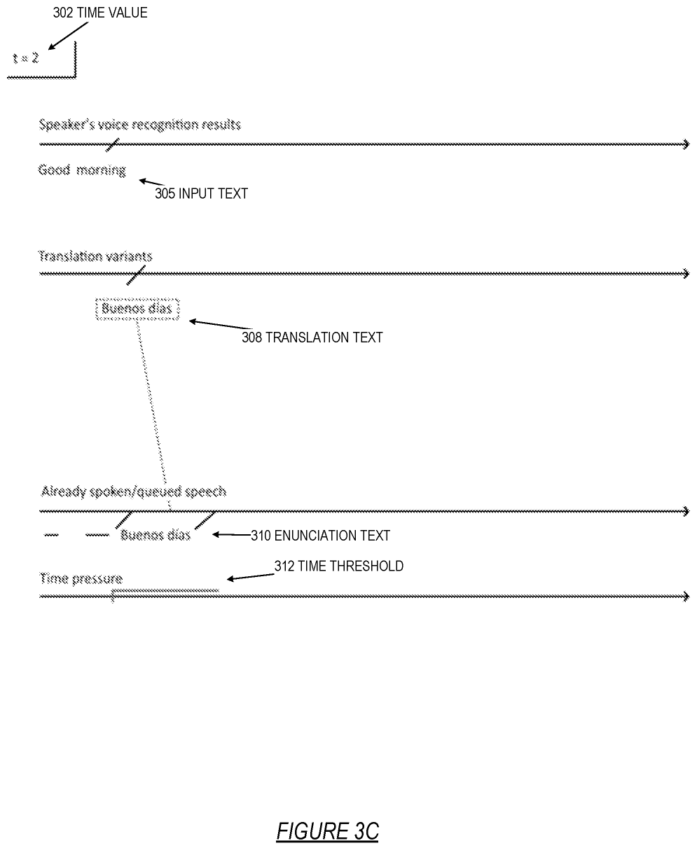

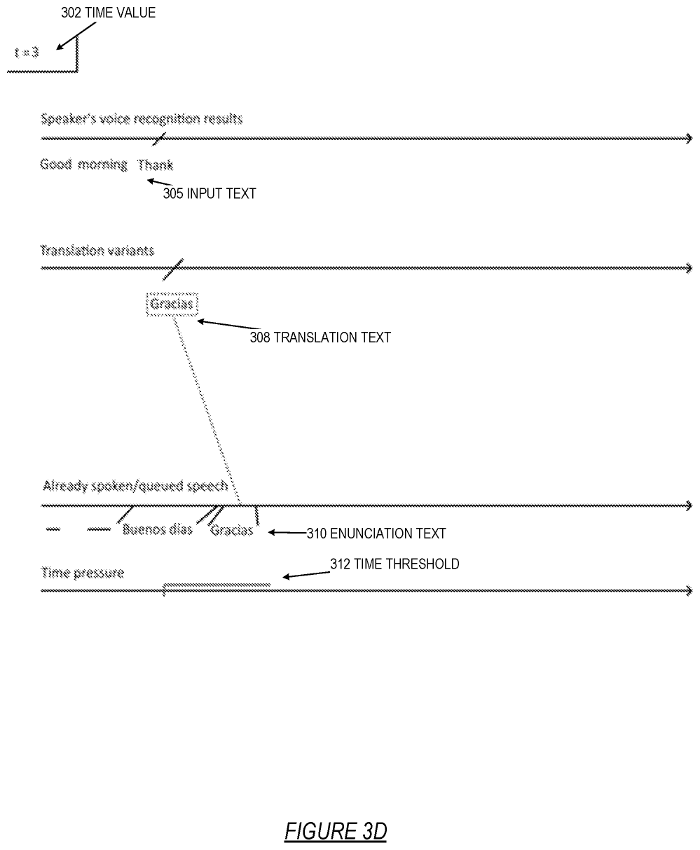

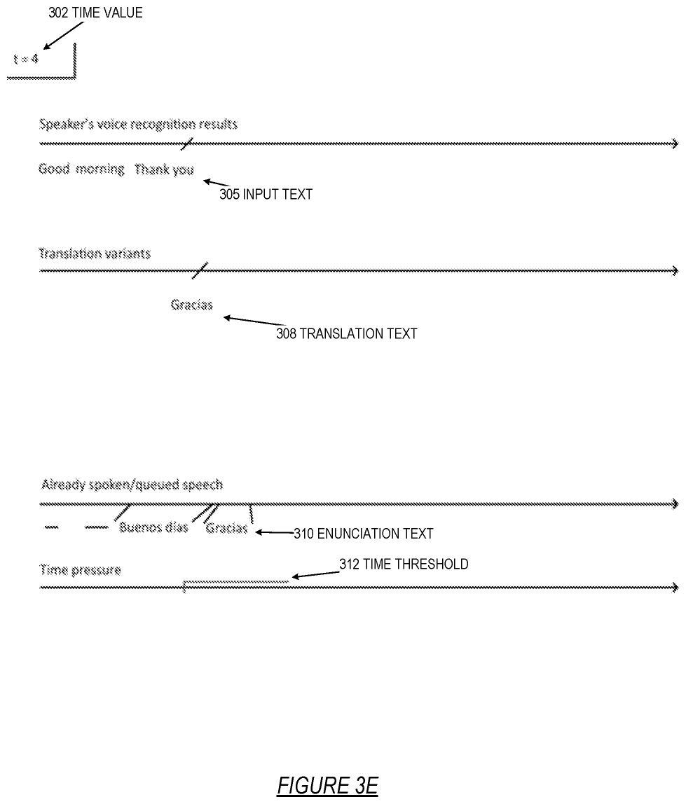

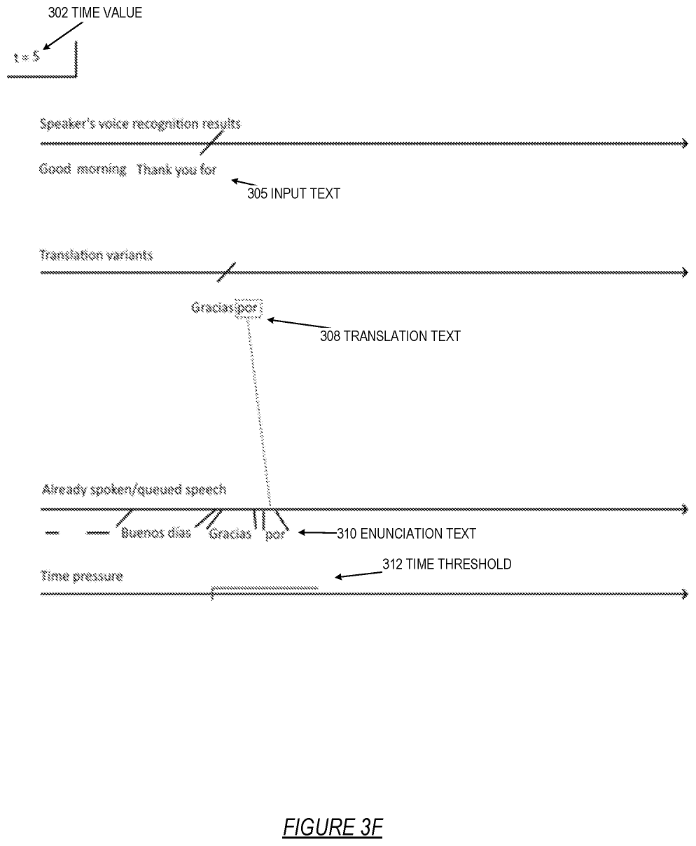

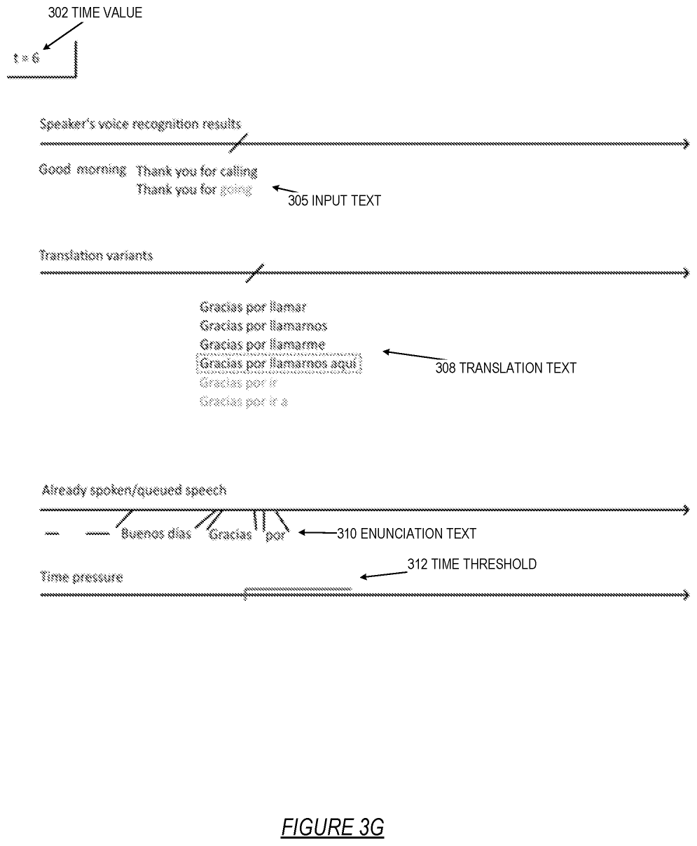

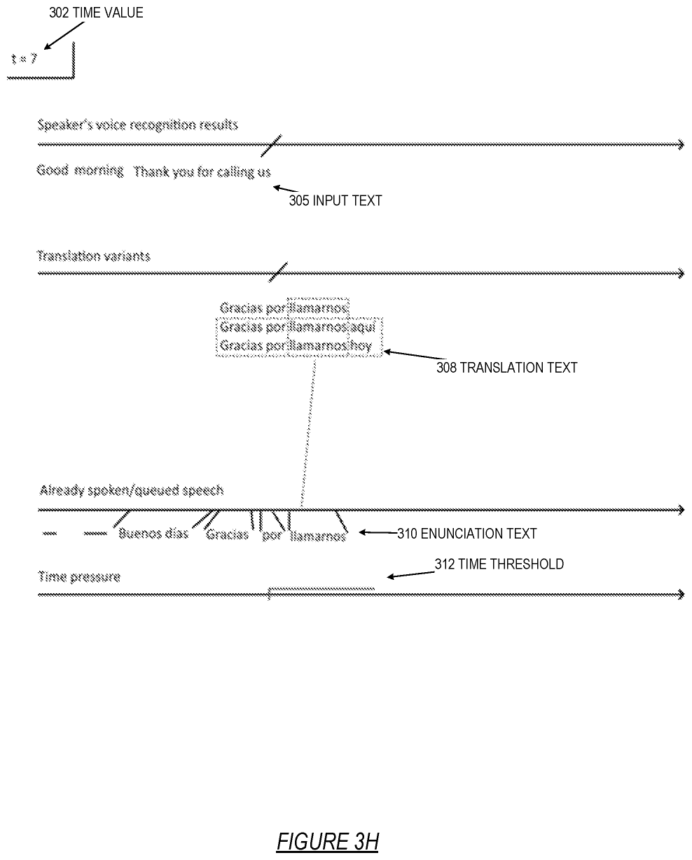

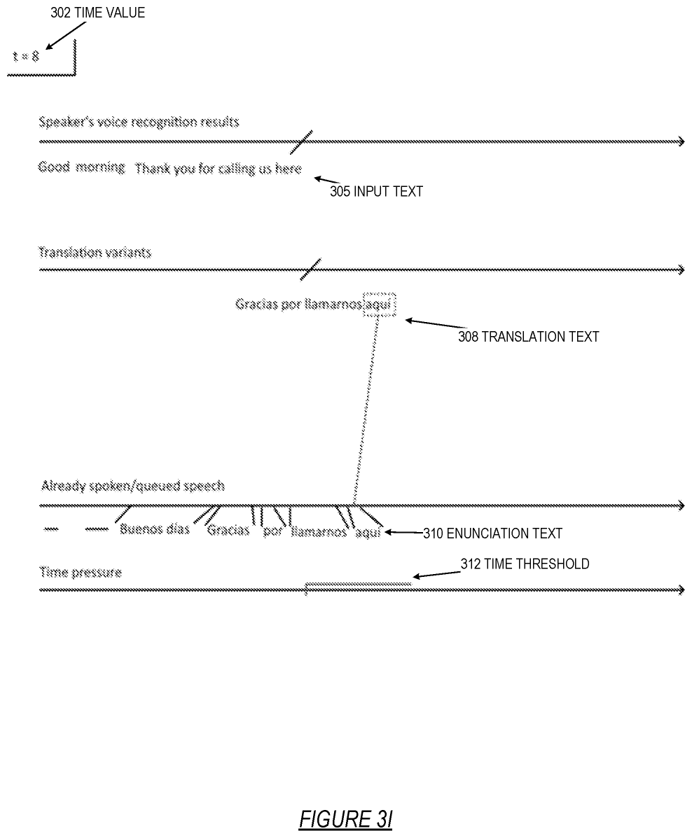

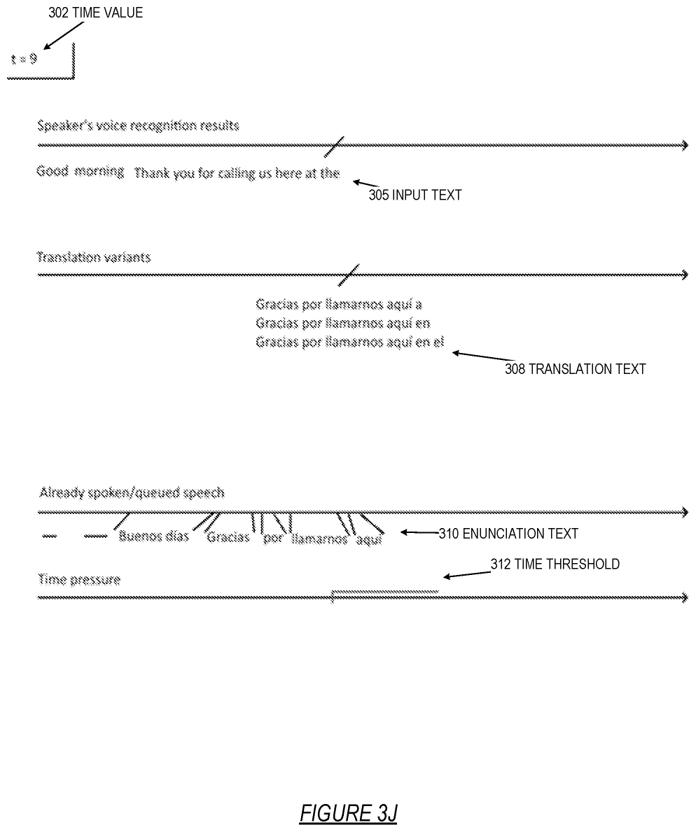

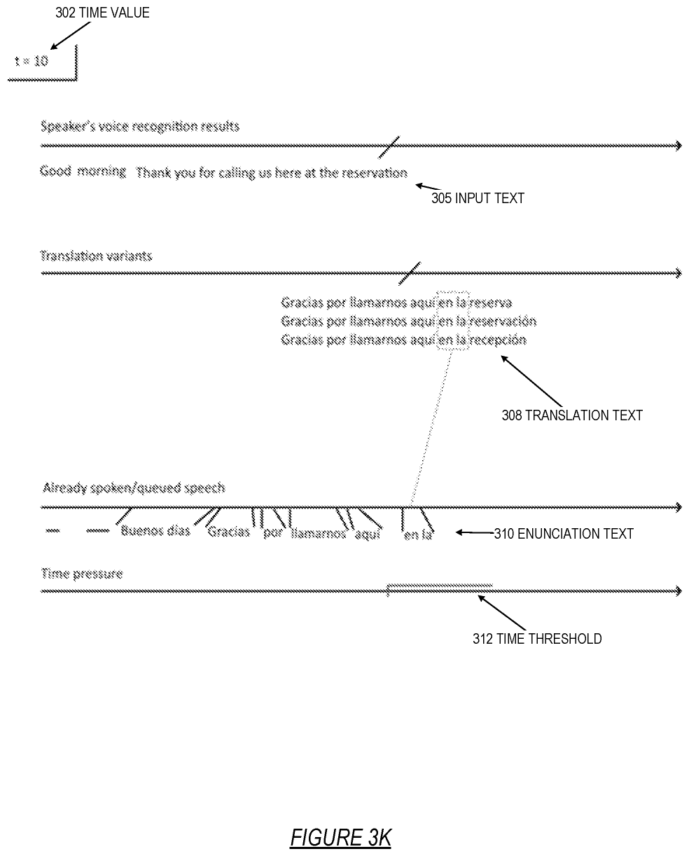

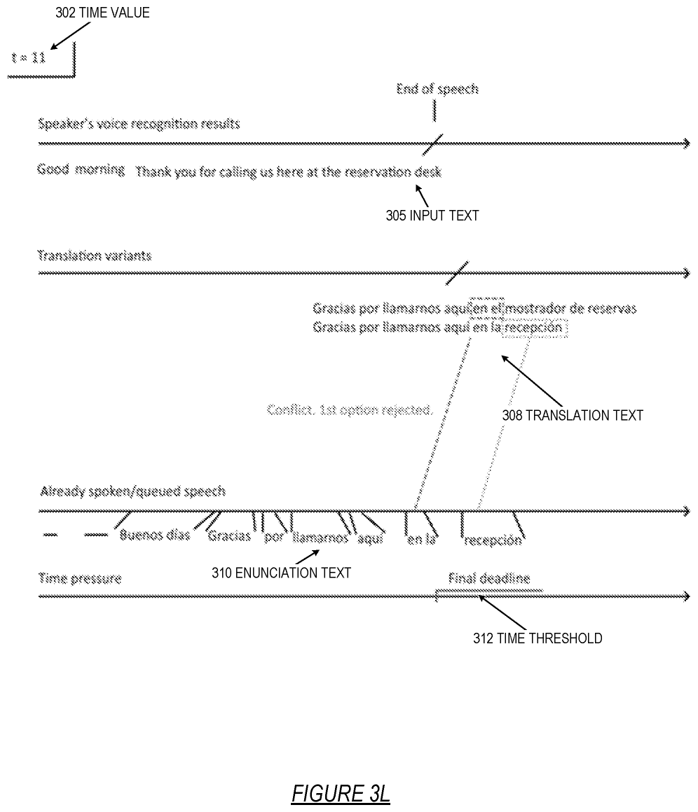

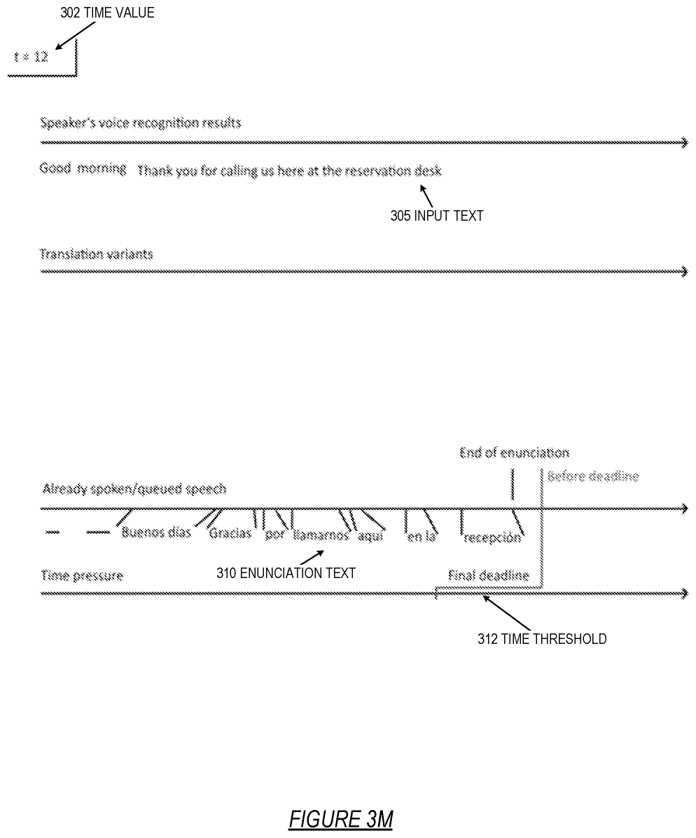

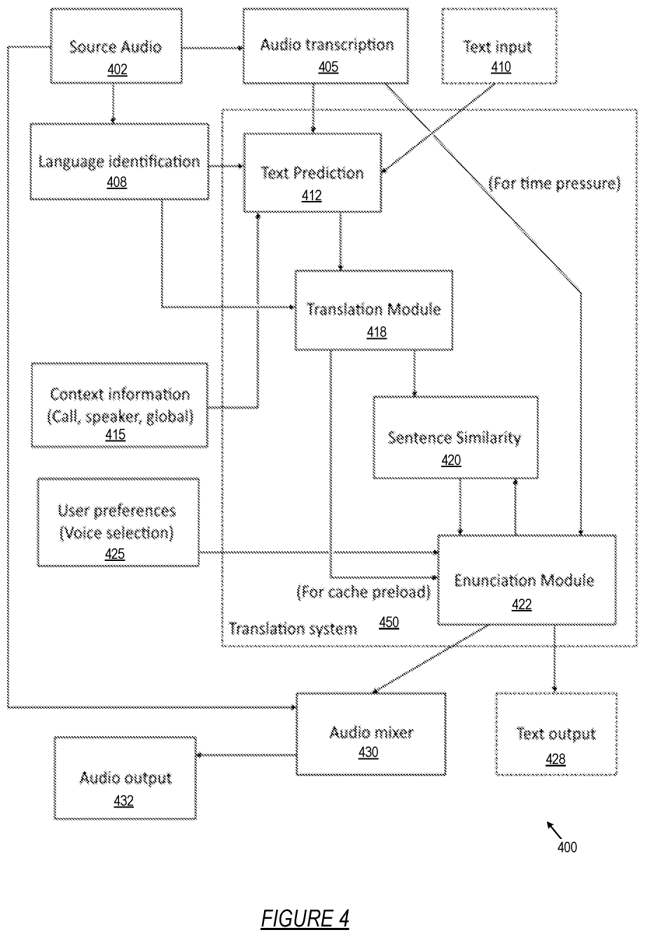

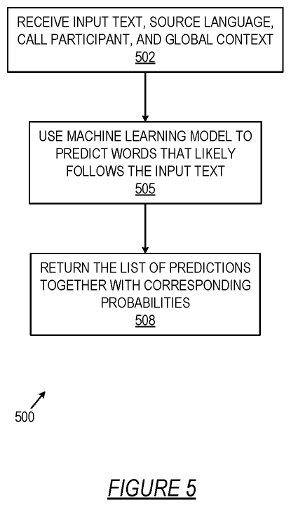

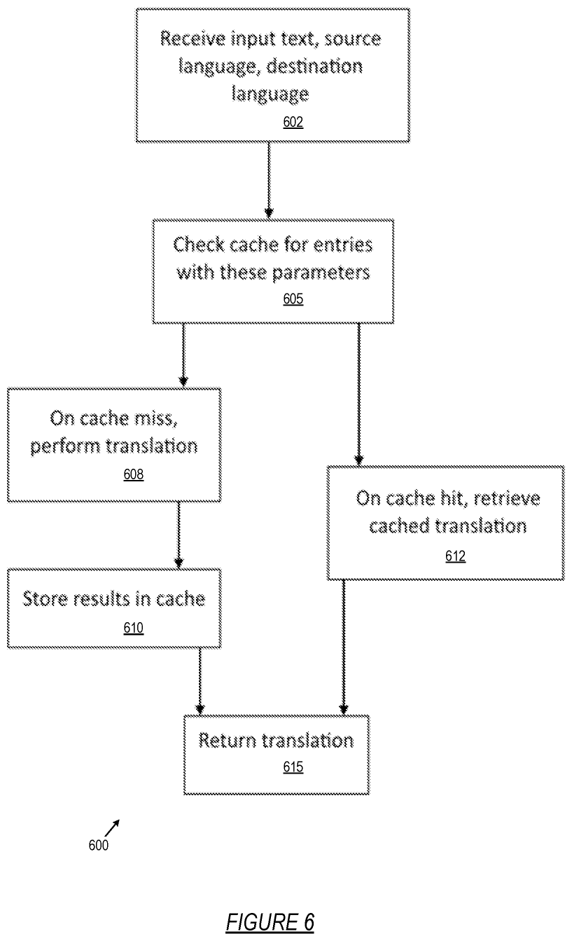

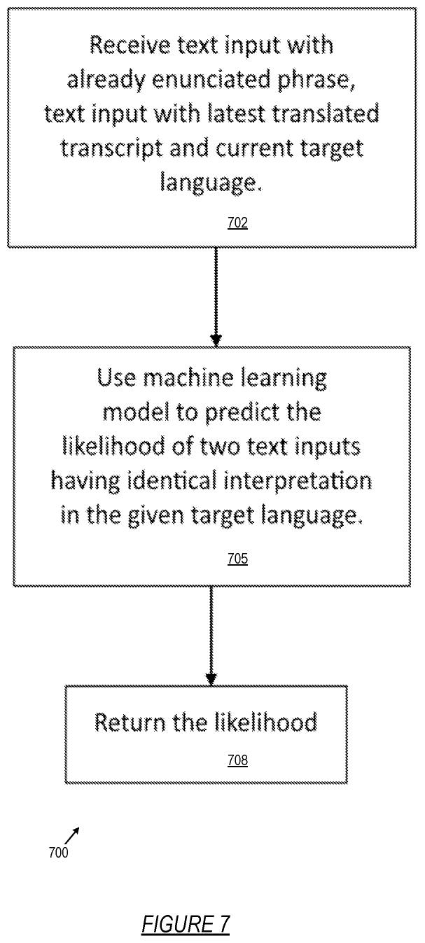

FIG. 3A through FIG. 3M show a sequence for translating user input with time pressure. In one embodiment, the data and timelines depicted in FIG. 3A through FIG. 3M may be displayed on a user interface to present a live translation sequence to a user.

Turning to FIG. 3A, a communication session is initiated with the time value (302) set to “0”. The system receives the input text (305) “Good”. The input text (305) is processed with prediction and translation models to generate the translation text (308). The enunciation text (310) is empty as no translations have been played back to the user. The time threshold (312) shows a length of time of about 2 seconds for a translation of a word from the input text (305) to be presented (e.g., played) to the user.

The translation text (308) includes several potential translations for the input text (305) “Buena”, “Bueno”, “Buen”, and “Bien”. Additionally, the prediction model provides additional potential translations “Buenos días”, “Buenos tardes”, and “Buenos noches”.

Turning to FIG. 3B, the time value (302) is updated to “1” and the input text (305) is updated to “Good morn” to include a portion of the word as the user is speaking. The updated input text (305) is processed by the prediction and translation models to generate an update to the translation text (308). The translation text (308) is reduced to two potential translations “Buena mañana” and “Buenos días”. The enunciation text (310) remains empty and the depiction of the time threshold (312) slides to the right.

Turning to FIG. 3C, the time value (302) is updated to “2” and the input text (305) is updated to “Good morning”. The updated input text (305) is processed by the prediction and translation models to generate an update to the translation text (308). The translation text (308) is reduced to a single translation “Buenos días”. The translation text (308) is queued to the enunciation text (310) to be presented to the user. The time threshold (312) slides further to the right to keep pace with receipt of the input text (305).

Turning to FIG. 3D, the time value (302), the input text (305), translation text (308), the enunciation text (310), and the time threshold (312) are updated based on additional utterances. The input text (305) is updated to include “Thank”, which is translated to “Gracias” in the translation text (308), which is pushed to the enunciation text (310). The time threshold (312) slides further to the right to keep pace with receipt of the input text (305).

Turning to FIG. 3E, the time value (302) is updated to “4” and the input text (305) is updated to “Good morning Thank you”. After processing by the translation and prediction models, the translation text (308) remains the same as well as the enunciation text (310). The time threshold (312) continues to slide to the right.

Turning to FIG. 3F, the time value (302) is updated to “5” and the input text (305) is updated to “Good morning Thank you for”. After processing by the translation and prediction models, the translation text (308) is updated as well as the enunciation text (310). The time threshold (312) continues to slide keeping pace with the input text (305).

Turning to FIG. 3G, the time value (302) is updated to “6” and the input text (305) is updated to include a potential variant with the word “going”. After processing by the translation and prediction models, the translation text (308) is updated to include multiple variants. There is no change to the enunciation text (310) and the time threshold (312) continues to slide.

Turning to FIG. 3H, the time value (302) is updated to “7” and the input text (305) is updated to “Good morning Thank you for calling us”. After processing by the translation and prediction models, the translation text (308) is updated to include fewer variants that each include the word “llamarnos”, which is pushed to the enunciation text (310). The time threshold (312) continues to slide.

Turning to FIG. 3I, the time value (302) is updated to “8”, the input text (305) is updated, and the translation text (308) and the enunciation text (310) are updated based on the changes to the input text (305). The time threshold (312) continues to slide.

Turning to FIG. 3J, the time value (302), the input text (305), and the translation text (308) are updated. There is no change to the enunciation text (310) and the time threshold (312) continues to slide.

Turning to FIG. 3K, the time value (302), the input text (305), the translation text (308), and the enunciation text (310) are updated. The time threshold (312) continues to slide.

Turning to FIG. 3L, the time value (302), the input text (305), the translation text (308), and the enunciation text (310) are updated. The time threshold (312) continues to slide. The first translation variant in the translation text (308) is rejected. In one embodiment, the first translation variant is rejected because the time to enunciate the first translation variant would exceed the time threshold (312).

Turning to FIG. 3M, the time value (302) is updated to “12” and there is no change to the input text (305) or to the enunciation text (310). The time threshold (312) remains in the same horizontal space in keeping with the input text (305).

FIG. 4 through FIG. 12 depict examples of systems and methods that implement probabilistic multi-party audio translation. The systems and methods may be implemented on computing systems as described in FIG. 13A and FIG. 13B.

Turning to FIG. 4, the system (400) includes the translation system (450) that that implements probabilistic translation. The source audio (402) is received by the system (400) and is used to generate the audio transcription (405) and the language identification (408). Additionally, the system (400) may receive the text input (410). The audio transcription (405), the corresponding language identification (408), and the text input (410) are input to the text prediction module (412).

The text prediction module (412) generates predictions that may be output to the translation module (418). The text prediction module (412) may also receive the context information (415), which may include information about the call, a speaker, metadata, etc.

The translation module (418) translates the output from the text prediction module (412), may be provided to the sentence similarity module (420) and the enunciation module (422). The translation module (418) may additionally receive the language identification (408).

The sentence similarity module (420) receives the output from the translation module (418). The sentence similarity module (420) compares the output of the translation modem (418) to what has been enunciated to a user. The output of the similarity module (420) is sent to the enunciation module (422).

The enunciation module (422) receives outputs from the translation module (418) and the similarity module (420) and may also receive the user preferences (425). The enunciation module (422) may drive the text output (428) and the audio mixer (430). The text output (428) includes translated text generated from one or more of the source audio (402) and the text input (410). The audio mixer (430) generates translation audio for the translation of the source audio (402) and presents the translation with the audio output (432). In one embodiment, audio output (432) may be an audio speaker of a computing device.

A language-specific text prediction model of the text prediction module (412) may be used both before and after the translation module (418). The prediction model receives the input, including current speech transcription (or any user-generated plain text), together with any available data (e.g., about previous sentences used in this conversation, about previous sentences used by a current speaker/author, about the speaker/author, about other call/conversation participants, etc.) making up current context. The text prediction model uses context-aware model of speech to produce one or more hypothesis containing zero or more words. For example, the phrase may be “Hello, my name is”, and the prediction model may use the information about the participant (e.g., first name, last name) and call context (e.g., introductions made by other participants) to predict the next word or words in the phrase. Other styles of introductions (e.g., first name or full name) may be used. If there were no prior introductions then a typical format for the user (e.g., user may introduce themselves using their full name) may be used. In some implementations, these predicted phrases will be passed down the translation pipeline to populate the downstream caches (e.g., translation phrase cache, similarity model results cache, enunciation module cache). In other implementations, enunciation may be produced for predicted text with very high predicted likelihood (e.g., above predetermined threshold). In each case, the text with any predictions and hypotheses (e.g., alternative spelling of original input text) is passed to the translation module (418).

In one embodiment, the translation module (418) performs neural-network-based translation between language pairs using a translation model, providing alternative translation hypothesis where appropriate and available. The translation model receives text input and produces one or more text outputs with accuracy coefficients. A translation module cache may be used, which may improve the translation speed for well-known or previously translated phrases. Some translations may be loaded into cache directly from the server (e.g., without first being seen by this instance of the translation system). Other translations may be added to a session (e.g., used by one instance of the translation system) or global (e.g., shared between multiple instances of the translation system) cache after first seen by the translation module (418). In each case, the translated text with any alternative translations (e.g., translation hypotheses, translations of input text hypotheses, translation of predicted phrases) will be passed to language-specific sentence similarity model, together with the current enunciated (e.g., already enunciated or queued for immediate enunciation) output.

A language-specific sentence similarity model of the sentence similarity module (420) is used for determining the likelihood of already enunciated divergent translation (compared to the most recent translation candidate) carrying the same meaning to the listener. For example, if the enunciated translation candidate was “we are meeting at seven” and the current translation candidate is “we are meeting at seventeen hours”, the likelihood of proper interpretation would be low (e.g., below the predetermined threshold) and correction is enunciated for the word “seven”. In another example, if the enunciated translation candidate was “we present our engine for translation” and the current (e.g., latest) translation candidate is “we present out translation engine”, the likelihood of proper interpretation would be high (e.g., above the predetermined threshold) and correction is not enunciated, and the translation should advance beyond this phrase. Furthermore, if the likelihood is below the threshold and correction is to be enunciated, then the same model may be used to find the most suitable correction that would carry the intended meaning. A cache may be used to store likelihood scores of phrase pairs, which may help improve the lookup speed and correction generation speed. In some implementations involving live audio translation, when the enunciation (e.g., with or without corrections) is prepared, it is passed to the enunciation module (422). In some implementations, the enunciation may be returned as plain text to the invoking code (e.g., to be displayed on the screen, to be stored in a text file or log, etc.).

The enunciation module (422) performs speech synthesis (e.g., conversion of input phrase into synthesized speech). The enunciation module (422) may predictively request speech synthesis for one or more received phrases. The enunciation module (422) may store one or more synthesized phrases to speed up the time between suitable enunciation being determined (e.g., in the previous stage) and the suitable enunciation being heard by the target user (e.g., speech synthesis output sent to the audio mixer (430)). In some implementations, the enunciation module (422) may dynamically manage the dictionary of stored speech synthesis results to conserve device memory. The enunciation module (422) maintains the queue of utterances to be enunciated and may provide the state of the queue and already enunciated utterances to other stages of translation (e.g., similarity model stage).

Additionally, ducking (mixing of audio of the speaker at a reduced level with audio of the translation) may be employed. Ducking provides audible queues between when the speaker begins speech, and the translator begins enunciating words.

Furthermore, manual (e.g., via user interface the speaker may hear the options and pick the desired one) and automatic (e.g., using audio analysis to determine the perceived voice gender of the speaker and possibly other parameters, and use them to find similar voice in target language) selection of enunciation voice is allowed. For example, the first user may select the voice that may be attributed to senior female, while the second user may select the voice that may be attributed to a young male. Use of different voices for different users permits listening participants in multi-party calls (e.g., where speech of multiple participants is being translated) to distinguish between multiple speakers more easily.

Together, the components of the system (400) provide a near-instant translation. The system may be capable of enunciating speech nearly at, or in some circumstances (e.g., when text prediction model produces high likelihood phrases) above the speed of speech of the speaker.

In some implementations, time pressure may be used to speed up the translation. Time pressure may be defined as a period of time (e.g., predetermined) within which the translation should be enunciated after the speaker has finished their speech. Time pressure may be a best-effort metric (e.g., not guaranteed). For example, the time pressure may be described by the users as the period of time that the speaker waits until each of the listeners are likely to have heard them in a desired language. Time pressure may be used to prevent user frustration from having to wait in silence with each of the call participants until each person has heard the translation. For example, if the time pressure is predetermined to be five seconds, then at most, the speaker will have to wait for five seconds until the last listener has likely heard the translation.

Time pressure can be used by the enunciation module (422) to control the playback rate of the queued utterances. If the speech has ended (e.g., no new input text was received), then the time since when the last text input was received, and time pressure value can be used to determine the playback rate (also referred to as an acceleration coefficient) to be applied by the enunciation engine. For example, if one second has passed since the speech has ended and time pressure value is five seconds, then acceleration coefficient may be one (e.g., no acceleration). In another example, if four seconds have passed since the speech has ended and time pressure value is four seconds, then maximum (e.g., predetermined) acceleration coefficient may be applied (e.g., 1.25x).

Turning to FIG. 5, the process (500) implements text prediction and may be executed by text prediction module (412) of FIG. 4. At Step 502, input text, a source language, a call participant, and a global context are received. In one embodiment, the input text may be text that is transcribed from user speech. In one embodiment, the source language is identified with a source language identifier (e.g., a text string or numerical value) that identifies the language of the input text (e.g., “English” or “1”). In one embodiment, the call participant is identified with a participant identifier, which may be an e-mail address for the user participating in the call. In one embodiment, the global context may include additional metadata regarding the call, which may include user location information, call connection information, etc.

At Step 505, a machine learning model is used to predict words that likely follows the input text. In one embodiment, the machine learning model may be a large language model that receives the input text and outputs predicted text. In one embodiment, the output from the machine learning model may be set to include no more than a predefined number of words, tokens, or phrases and may be set to stop on a specified type of word or token. For example, the system may specify that no more than five words after the input text are predicted. As another example, the system may specify that the machine learning model stops predicting additional words when a stop word or stop token is reached (e.g., a period “.”, a comma “,”, etc.).

At Step 508, a list of predictions together with corresponding probabilities are returned. In one embodiment, the predictions in the list are stored as text strings. The list and probabilities may be returned by the machine learning model. The probabilities identify a numerical confidence (e.g., from 0 to 1) that a prediction from the list is in accordance with the intended meaning of the input text.

Turning to FIG. 6, the process (600) implements translation and may be executed by translation module (418) of FIG. 4. At Step 602, input text, a source language, and a destination language are received. The identifiers for the source language and the destination language may be text strings or numerical values. The source language may be detected from the input text and the destination language may be identified from a user profile. In one embodiment, the destination language may be determined from speech or text captured by the system from the user, which the system then identifies as the destination language for the user.

At Step 605, a cache is checked for entries corresponding to the received parameters. The received parameters include the input text (or words or phrases therefrom), the source language, and the destination language. Use of the cache improves the speed of translation by bypassing the machine learning model when the same input text is received multiple times during a call.

At Step 608, translation is performed using the translation model on a cache miss. A cache miss is when the input parameters for translation (e.g., the input text and the source and destination language identifiers) do not have an entry in the cache. When there is no entry in the cache for the input parameters, the system performs a translation of the input text with the translation model.

At Step 610, results are stored in the cache. The results include the translation (text, tokens, word vectors, etc.) generated by the translation model after detecting a cache miss and performing the translation.

At Step 612, a cache translation is retrieved on a cache hit. A cache hit is when the input parameters are identified by an entry in the cache. When the input parameters are identified by an entry in the cache, the translation corresponding to the input parameters is retrieved by the system.

At Step 615, the translation is returned. The translation may be from the cache on a cache hit of the input parameters and may be a new translation performed on the input text when there is a cache miss for the input parameters.

Turning to FIG. 7, the process (700) implements sentence similarity detection and may be executed by the sentence similarity module (420) of FIG. 4. At Step 702, text inputs and a target language are received. The target language identifies the language used by the text inputs. One of the text inputs includes an already enunciated phrase, i.e., a phrase already played back to a user. Another text input is translation data with the latest translated transcript.

At Step 705, a machine learning model is used to predict the likelihood of the two text inputs having the same or similar interpretation given the target language. In one embodiment, the text inputs may be converted to word vectors and input to the machine learning model. In one embodiment, the likelihood output from the machine learning model identifies the similarity between the text inputs with a value between “0” and “1” with a value of “0” being no similarity and a value of “1” being identical.

At Step 708, the likelihood is returned. In one embodiment, the likelihood is a similarity score, which may include values for each of the pairs of corresponding words from the texts input to the machine learning model.

FIG. 8A through FIG. 8D show processes that may be executed by the enunciation module (422) of FIG. 4. Turning to FIG. 8A, the process (800) performs cache preloading for an enunciation cache that stores synthesized audio that may be played back to a user. At Step 802, a set of transcripts and augmented transcripts are received from a translation module. In one embodiment, a transcript includes a sequence of one or more words, which may be stored as text, tokens, word vectors, etc.

At Step 805, for each entry in the transcripts and augmented transcripts, a probability is checked against a predetermined threshold and transcripts below the threshold are dropped. In one embodiment, the probability is a similarity score determined by a similarity module.

At Step 808, with passing transcripts, the cache is checked for the presence of corresponding audio data in a corresponding language. In one embodiment, a passing transcript is a transcript in which the similarity score met the similarity threshold.

At Step 810, if no match is found in the cache, the system synthesizes audio data for the transcript and stores the audio data in the cache. In one embodiment, the synthesized audio data is in the destination language.

Turning to FIG. 8B, the process (825) implements a playback queue for enunciation of audio data from a translation to a user. At Step 828, the system reads the enunciation queue containing utterances with audio data ready or with pending audio data. The audio data that is ready is already loaded in the queue. The pending audio data is audio data that is being synthesized by the system and will be loaded into the queue upon synthetization.

At Step 830, the system waits for pending audio data. In one embodiment, the pending audio data is saved to the enunciation queue after being synthesized from translation data.

At Step 832, the system waits for current enunciation, if any, to stop playing. In one embodiment, the current enunciation is audio being played to a user as part of a communication session.

At Step 835, the system launches playback using the current playback rate calculated from the time pressure value. The playback plays the audio corresponding to the translation for the user.

At Step 838, the system sends a message with updated combined enunciation. The updated combined enunciation identifies the words that have been enunciated to the user.

Turning to FIG. 8C, the process (850) updates values related to time pressure. At Step 852, the system receives a call transcript finalized message that indicates the end of an utterance. In one embodiment, the call transcript finalized message may be generated upon the detection of a pause by the speaker that is being translated. As an example, a pause may be when the speaker does not speak for a pause threshold duration, e.g., 3 seconds.

At Step 855, the system updates a time pressure value. In one embodiment, a time threshold of 2 seconds is set so that enunciation is to be played within two seconds of a speaker having spoken a word. The system may identify the playback time for the synthesized audio to be played back and determine if the playback of the synthesized audio is able to finish within the time threshold. If not, the system may adjust the playback rate to increase the playback speed so that the playback of the synthesized audio will finish within the time threshold.

Turning to FIG. 8D, the process (875) implements enunciation preparation. At Step 878, the system receives translated transcript to be enunciated. In one embodiment, the translated transcript is determined by a similarity score generated between translation data and enunciation data.

At Step 880, the system checks the cache for the received transcript and the destination language. The destination language identifies the language of the received transcript, which may be matched to the language of the audio in the cache.

At Step 882, if audio data is found in the cache, then the enunciation is queued with the cached audio data. In one embodiment, the cached audio data is previously synthesized text for the same word, phrase, sentence, etc., from the transcript.

At Step 885, if audio data is missing from the cache, enunciation is queued and a request for audio synthesis for the queued enunciation is sent. In one embodiment, the enunciation may be a portion of the transcript that is queued for playback to the user.

Turning to FIG. 9, the process (900) depicts a flow of data through the system. The first user speaks a phrase that is captured as speaker audio by the system. At Step 902, a speech-to-text service transcribes the audio from the speaker to text, which may include the interim results. At Step 905, a text prediction model computes possible endings for the phrase spoken by the user. At Step 908, a translation module produces translations for a transcript in the language of the speaker, as well as predicted transcripts in the language of the speaker. At Step 910, similarity scoring is performed with a sentence similarity model that analyses current output and the latest translated transcription to determine if correction updates should be applied. At Step 912, enunciation preparation is performed, e.g., by determining a portion of a transcript to playback for a user. At Step 915, enunciation is performed with an enunciation module that generates an audio file stream and a caption stream which may pre-cache transcript, enunciation, and audio data. The enunciation module outputs the audio and caption streams at an appropriate rate.

In one embodiment, voice data is converted to text data. The speech transcription is generated using an appropriate (e.g., selected based on the source content type (phone audio, broadband audio, etc.) and language) speech recognition machine learning model. The speech recognition machine learning model may produce one or more hypotheses, also known as interim transcriptions or interim results, for the same input audio chunk, and may assign recognition accuracy to each hypothesis. For example, the audio may contain the phrase “apple is green” and the produced transcriptions could be: “apple is green” with 0.96 accuracy, “apples green” with 0.09 accuracy, and “apple's green” with 0.05 accuracy. A threshold value (e.g., predetermined) may be used by the system to discard some of the interim transcriptions that have insufficient accuracy to be considered.

In one embodiment, text data is processed to generate predicted text data with a prediction model corresponding to the language of the transcripts. The prediction model receives one or more transcriptions (e.g., interim, or final) and may produce zero or more predicted phrases with corresponding probabilities, that could follow each of the supplied transcripts. For example, for transcript “apples grow” and using United States English prediction model, the produced prediction phrases may be: “on trees” with 0.97 probability, “in fall” with 0.51 probability, “(e.g., the supplied phrase is already complete)” with 0.22 probability, and “in florida” with 0.06 probability. A threshold value (e.g., predetermined) may be used by the system to discard some of the predictions that have insufficient probability to be considered.

In one embodiment, the predicted text data is converted from a first language to a second language to generate one or more sets of translated text data. A translation module receives the set of one or more original transcripts (e.g., interim, or final), a set of zero or more transcripts with corresponding predicted phrases appended (e.g., augmented transcript), the source language, and the target language. The translation module uses the appropriate translation method most suitable for the given language pair (e.g., neural machine translation) to produce one or more translation results, sorted by their corresponding relative accuracy scores (e.g., between 0 and 1). In some implementations, the translation is performed individually for each received transcript and augmented transcript. In other implementations, the translation results for each of the inputs are combined into one list, with relative accuracy scores computed for that entire list. For example, the transcript “apples grow” with United States English source language and Mexican Spanish target language, may produce these translations: “manzanas crecen” with 0.98 relative accuracy score and “crecen las manzanas” with 0.26 relative accuracy score.

In one embodiment, selected text data is selected from the sets of translated text data. If no enunciation (e.g., through audio, or visually on screen) was performed and no enunciations were queued, then the most suitable (e.g., highest combined recognition accuracy, translation accuracy, and where applicable prediction probability) translated transcript (e.g., transcript, augmented transcript) can be queued for enunciation. If some translated speech (e.g., from the current sentence, phrase, segment of speech, etc.) was already enunciated or is currently queued for enunciation, then checks are performed to avoid mistakes (e.g., omission, addition, misinformation, misorder, or blends) in the resulting enunciation. Sentence similarity model corresponding to the enunciation language may be given two inputs: a portion of the already enunciated with queued enunciations appended thereto, and corresponding portion of the most suitable translated transcript. The model may produce a probability score (e.g., between 0 and 1) of two inputs being perceived as meaning the same thing. A threshold value (e.g., predetermined) may be used by the system to determine if two inputs should be considered sufficiently distinct that an explicit correction should be enunciated. For example, the already enunciated phrase in United States English may be “today we will be watching a movie”, the entirety of the most suitable translated transcript may be “today we are seeing a movie in cinema” and the corresponding portion of the most suitable translated transcript may be “today we are seeing a movie”, and the resulting similarity score would be 0.98, which may be above the threshold value, thus the already enunciated phrase could be considered as sufficiently accurate and no correction enunciation has to be issued. For example, the phrase queued may include that which is “new”, i.e., added since the already enunciated portion, namely “in cinema”, so the final enunciation would be “today we will be watching a movie in cinema”.

In one embodiment, the selected text data is converted to translated voice data, where the enunciation module is responsible for preparing the audio files or stream of timed captions updates that correspond to the flow of translated speech. When the phrase is queued for enunciation, the enunciation module interacts with an appropriate (e.g., relevant language and assigned voice) text-to-speech service, which converts the provided text string into an audio file. The enunciation module may receive text inputs that represent potential future enunciations, based on the predicted and translated phrases from previous stages. The enunciation module may process these text inputs containing potential future enunciations, use text-to-speech service to produce corresponding audio files, and store these audio files in session (e.g., single translation session) or in global (e.g., user account level, service level) cache. The enunciation module may load audio data from cache when available, instead of interacting with text-to-speech service to generate new audio data.

In one embodiment, the translated voice data is played to the user as part of a live streaming conference, the enunciation module contains the enunciation queue, which represents an ordered list of enunciations that are to be played at a natural speed back to the user. In some implementations, the enunciation module can control the playback speed dynamically based on the external signals (e.g., time pressure—the time passed since the last phrase was spoken by the user). The enunciation service may accelerate the playback of queued enunciations or resume the playback at a normal rate (e.g., default playback rate). The enunciation module may produce text feed that is displayed as closed captions to the user. The rate at which new captions appear on the screen may match the speed of audio being played back by the enunciation module.

Turning to FIG. 10, the user interface (1000) displays a multi-party conversation. The conversation is between three speakers of different languages and voices.

The first user (1002), the second user (1005), and the third user (1008) may be participating in a video conference call. The first user (1002) speaks English, the second user (1005) speaks Spanish, the third user (1008) speaks Chinese and English. Each user may have previously used the user interface of the conferencing service to list languages which a user can comprehend. The translation system may be provided with this information as each participant connects to the video call. Each participant, except for own placeholder and participants that speak the same language as the viewer, an overlay indicator is shown that may affirm to the viewer that the translation system is enabled.

The translation system may detect that at least one call participant (e.g., the second user (1005)) may hear translated speech from two or more other participants, which may trigger assignment of distinct enunciation voices to translations of speech of the first user (1002), the second user (1005), and the third user (1008). The voices may be assigned randomly or respecting the user-specified gender, if available.

When the first user (1002) greets everybody, speaking English, the second user (1005) may hear a near-instant translation, produced by the translation system, of the greeting in Spanish, while also hearing the original voice of the first user (1002) at reduced volume in sync with the first user (1002) video image. The third user (1008) may hear the greeting of the first user (1002) at an original voice volume and in sync with the video image, as the third user (1008) had previously indicated comprehension of English language.

When the second user (1005) responds to the greeting in Spanish, the first user (1002) may hear the near-instant translation, produced by the translation system, of the greeting response of the second user (1005) in English, while the third user (1008) may hear a different translation, produced by the translation system, of the greeting response of the second user (1005) in Chinese (e.g., preselected preferred translation language). Both the first user (1002) and the third user (1008) may hear the voice of the second user (1005) at a reduced volume and in sync with the video image of the second user (1005).

When the third user (1008) replies to the greeting in Chinese, the first user (1002) may hear near-instant translation, produced by the translation system, of the greeting in English, enunciated by a voice distinct from the second user (1005) translation enunciation voice. At the same time, the second user (1005) may hear near-instant translation, produced by the translation system, of the greeting in Spanish, enunciated by a voice distinct from the first user (1002) translation enunciation voice. Both the first user (1002) and the second user (1005) may hear the voice of the third user (1008) at a reduced volume and in sync with the video image of the third user (1008).

FIG. 11A through FIG. 11D display updates to the user interface (1100) for a live video stream. The live video stream includes translated real-time closed captions with a correction issued by updating the already displayed captions.

The first user may join a public live stream hosted by a third-party (e.g., live streaming platform). The first user may not know in advance what spoken language is used during the live stream and the first user may decide to enable translation system immediately. An indicator icon may display as an overlay in the corner of the video, indicating that the translation was enabled successfully. The translation system may read stored user preferences information of the first user, and it may determine that the first user comprehends Italian, Japanese, and English, and the preferred translation language is English. The automatic translation of the stream title may read “Talking to subscribers (Translated from Russian)”, which may indicate that the stream will host two or more people talking, likely in Russian.

When the live stream audio is processed by the translation system, it may use live stream metadata (e.g., HTML meta tags on the page, live streaming platform API response, audio channel headers, etc.) or it may analyze the audio samples (e.g., using language identification machine learning model) to determine the currently spoken language of the stream. The translation system may repeat this analysis periodically (e.g., at predetermined intervals of five seconds) or for each utterance (e.g., short phrase delimited by sufficient pauses in speech).

The user may enable the translated closed captions in the translation system preferences, which may produce an overlay over the live video stream that would contain textual representation of the enunciated translation in Italian (e.g., preferred translation language). The translated closed captions may be shown in a contrasting font or on a contrasting background.

Turning to FIG. 11A, the live stream audio may contain the phrase [symbol] spoken in Russian, which may be recognized progressively: first as [symbol] , then as [symbol] . When the interim transcription containing the word [symbol] is received by the translation module, it may be translated as “go” in English. The translation system may request enunciation of the utterance “go” in English for the first user. The translation system may also direct the closed captions to be displayed on the screen containing the same word.

Turning to FIG. 11B, When the second half of the phrase is recognized and the final transcript of the utterance is ready, the translation module may translate the entire utterance as “let's go with us”. The sentence similarity model may be used to find the likelihood of “let's go” being interpreted as “go” for this utterance. The similarity likelihood may be determined to be high (e.g., low risk of misinterpretation) and the translation system may decide to queue the enunciation of “with us”, without issuing the correction enunciation. The translation system may also append the phrase to the closed captions display, without correcting the currently displayed word “go”, resulting in closed captions display showing “go with us”.

Turning to FIG. 11C, the live stream audio may contain the phrase [symbol] [symbol] spoken in Russian, which may be recognized progressively, including a bad interim transcription (underlined), as follows: (a) [symbol] , (b) [symbol] (c) [symbol] (d) [symbol] [symbol] , and (e) [symbol] . The transcriptions would be translated as described for the phrase [symbol] above. However, when performing the sentence similarity screening for the translation of the interim transcript (d), the comprehension threshold may not be reached: the word [symbol] and its corresponding translation “breakfast”, which was either already enunciated or it is present in the enunciation queue, could be sufficiently different from the word [symbol] and its corresponding translation “tomorrow”. Thus, a correction may be generated by the enunciation module, which may result in a phrase “err, tomorrow” being added to the enunciation queue after the word “breakfast”.

Turning to FIG. 11D, the enunciation module may produce the queued enunciations, namely the correction enunciation at the appropriate rate and at the appropriate timing (e.g., providing sufficient pauses when the source speech is slower than the default enunciation speed). The first user may hear the correction enunciation, followed by the rest of the translated phrase. The first user may see the closed captions, which are displaying the current translation on the screen, update to use the proper word. For example, the first user may hear “err, tomorrow” from their speakers, as well as see one word in closed captions being updated from “breakfast” to “tomorrow”.

Turning to FIG. 12, the first phone (1202) and the second phone (1205) are used in a phone conversation. The conversation is between users in two countries, context-specific, includes non-direct translation, and includes regional set phrases. In one embodiment, the corresponding translations are performed by the first phone (1202) and the second phone (1205). In one embodiment, the translations may be performed by a server connected between the first phone (1202) and the second phone (1205).

The first user, with a Portuguese phone number, is making an international call to the second user, with a French phone number. The translation is engaged when international call is detected on the first phone (1202) and the speaking language for the first user and for the second user is selected based on the country code of their corresponding phone numbers: the first user speaking language is set to Portuguese and the second user speaking language is set to French. The first phone (1202) shows the translation service icon and indicates which language was identified from country code of the destination phone number, in this case French. When the second user answers the call, the translation system may have already preloaded the information used for translation of the typical regional phone greetings.

The second user may say “Allô” upon answering the call, which the translation system may translate as “Estou”, which may not be a direct translation. The translation system may have in cache the enunciation for “Estou”, which may be played to the first user immediately, once “Allô” is recognized as having been said by the second user.

The first user is likely to respond with an introduction, as customary to phone conversations with unknown callers. The translation system may have preloaded a personalized introduction for the first user in Portuguese and the corresponding translation in French. The first user may respond with “Bom dia. Fala Maria Ferreira de SintraDecor.” The translation system may use the language model and current conversation context to predict that the first user may begin their speech with “Bom dia”. The translation system may use the preloaded translation for “Bom dia”, which may be “Bonjour” in French, and the corresponding enunciation to immediately commence the playback of the audio to the second user, once the word “Bom” is recognized in the speech of the first user. When the translation system recognizes the first user speaking “dia”, it may translate that utterance to French and verify that translation being enunciated (e.g., “Bonjour”) remains consistent with the current translation of the speech of the first user.

Once the “Fala Maria” is recognized in the speech of the first user, the translation system may translate the spoken utterance to “C′est Maria”, which may not be a direct translation, prepare the enunciation and commence the playback of audio to the second user as soon as the enunciation is ready. While the enunciation is being prepared and output to the second user, the rest of the response spoken by the first user would be recognized, namely “Ferreira de SintraDecor”. The translation system may translate the rest of the phrase to “Ferreira de SintraDecor àl'appareil” in French, which may not be a direct translation. The translated utterance would be prepared and queued for enunciation immediately after “C'est Maria” is enunciated.

Embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure. For example, as shown in FIG. 13A, the computing system (1300) may include one or more computer processors (1302), non-persistent storage (1304), persistent storage (1306), a communication interface (1312) (e.g., Bluetooth interface, infrared interface, network interface, optical interface, etc.), and numerous other elements and functionalities that implement the features and elements of the disclosure. The computer processor(s) (1302) may be an integrated circuit for processing instructions. The computer processor(s) (1302) may be one or more cores or micro-cores of a processor. The computer processor(s) (1302) includes one or more processors. The one or more processors may include a central processing unit (CPU), a graphics processing unit (GPU), a tensor processing unit (TPU), combinations thereof, etc.

The input device(s) (1310) may include a touchscreen, keyboard, mouse, microphone, touchpad, electronic pen, or any other type of input device. The input device(s) (1310) may receive inputs from a user that are responsive to data and messages presented by the output device(s) (1308). The inputs may include text input, audio input, video input, etc., which may be processed and transmitted by the computing system (1300) in accordance with the disclosure. The communication interface (1312) may include an integrated circuit for connecting the computing system (1300) to a network (not shown) (e.g., a local area network (LAN), a wide area network (WAN) such as the Internet, mobile network, or any other type of network) and/or to another device, such as another computing device.

Further, the output device(s) (1308) may include a display device, a printer, external storage, or any other output device. One or more of the output devices may be the same or different from the input device(s). The input and output device(s) may be locally or remotely connected to the computer processor(s) (1302). Many different types of computing systems exist, and the aforementioned input and output device(s) may take other forms. The output device(s) (1308) may display data and messages that are transmitted and received by the computing system (1300). The data and messages may include text, audio, video, etc., and include the data and messages described above in the other figures of the disclosure.

Software instructions in the form of computer readable program code to perform embodiments may be stored, in whole or in part, temporarily or permanently, on a computer program product that includes a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments of the invention, which may include transmitting, receiving, presenting, and displaying data and messages described in the other figures of the disclosure.

The computing system (1300) in FIG. 13A may be connected to or be a part of a network. For example, as shown in FIG. 13B, the network (1320) may include multiple nodes (e.g., node X (1322), node Y (1324)). Each node may correspond to a computing system, such as the computing system shown in FIG. 13A, or a group of nodes combined may correspond to the computing system shown in FIG. 13A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (1300) may be located at a remote location and connected to the other elements over a network.

The nodes (e.g., node X (1322), node Y (1324)) in the network (1320) may be configured to provide services for a client device (1326), including receiving requests and transmitting responses to the client device (1326). For example, the nodes may be part of a cloud computing system. The client device (1326) may be a computing system, such as the computing system shown in FIG. 13A. Further, the client device (1326) may include and/or perform all or a portion of one or more embodiments of the invention.

The computing system of FIG. 13A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

In the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an or may include any combination of the items with any number of each item unless expressly stated otherwise.

In the above description, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description. Further, other embodiments not explicitly described above can be devised which do not depart from the scope of the invention as disclosed herein. Accordingly, the scope of the invention should be limited only by the attached claims.

What is claimed is:

1. A method, comprising:
receiving input text of a communication session;
processing the input text with a prediction model and a translation model to generate translation data;
processing the translation data and enunciation data with a sentence similarity model to generate a similarity score; and
presenting the enunciation data based on the similarity score.

2. The method of claim 1, further comprising:
presenting the enunciation data using a time threshold identifying when the enunciation data for the input text is to be presented.

3. The method of claim 1, further comprising:
determining a playback rate using a time threshold and a time value of the input text; and
presenting the enunciation data using the playback rate.

4. The method of claim 1, further comprising:
processing the input text with the prediction model; and
processing output from the prediction model with the translation model to generate the translation data.

5. The method of claim 1, further comprising:
processing the input text with the translation model; and
processing output from the translation model with the prediction model to generate the translation data.

6. The method of claim 1, further comprising:
presenting the enunciation data as synthesized audio in an audio stream of a live media stream of the communication session.

7. The method of claim 1, further comprising:
presenting the enunciation data as subtitle text in a video stream of a live media stream of the communication session.

8. The method of claim 1, further comprising:
adjusting the enunciation data with the translation data when the similarity score satisfies a similarity threshold.

9. The method of claim 1, further comprising:
presenting a correction from the enunciation data after adjustment of the enunciation data when the similarity score satisfies a similarity threshold.

10. The method of claim 1, further comprising:
presenting a correction from the enunciation data after adjustment of the enunciation data and adjustment of a playback rate.

11. A system comprising:
at least one processor; and
an application executing the at least one processor configured to perform:
receiving input text of a communication session;
processing the input text with a prediction model and a translation model to generate translation data;
processing the translation data and enunciation data with a sentence similarity model to generate a similarity score; and
presenting the enunciation data based on the similarity score.

12. The system of claim 11, wherein the application is further configured to perform:
presenting the enunciation data using a time threshold identifying when the enunciation data for the input text is to be presented.

13. The system of claim 11, wherein the application is further configured to perform:
determining a playback rate using a time threshold and a time value of the input text; and
presenting the enunciation data using the playback rate.

14. The system of claim 11, wherein the application is further configured to perform:
processing the input text with the prediction model; and
processing output from the prediction model with the translation model to generate the translation data.

15. The system of claim 11, wherein the application is further configured to perform:
processing the input text with the translation model; and
processing output from the translation model with the prediction model to generate the translation data.

16. The system of claim 11, wherein the application is further configured to perform:
presenting the enunciation data as synthesized audio in an audio stream of a live media stream of the communication session.

17. The system of claim 11, wherein the application is further configured to perform:
presenting the enunciation data as subtitle text in a video stream of a live media stream of the communication session.

18. The system of claim 11, wherein the application is further configured to perform:
adjusting the enunciation data with the translation data when the similarity score satisfies a similarity threshold.

19. The system of claim 11, wherein the application is further configured to perform:
presenting a correction from the enunciation data after adjustment of the enunciation data when the similarity score satisfies a similarity threshold.

20. A method, comprising:
receiving input text of a communication session;
processing the input text with a prediction model and a translation model to generate translation data;
processing the translation data and enunciation data with a sentence similarity model to generate a similarity score; and
presenting the enunciation data based on the similarity score as synthesized audio in an audio stream of a live media stream of the communication session.
